(19) United States
(12) Patent Application Publication
(10) Pub. No.: US 2019/0174525 A1
(43) Pub. Date: Jun. 6, 2019

(54) METHOD FOR TRANSMITTING SCHEDULING REQUEST IN WIRELESS COMMUNICATION SYSTEM, AND APPARATUS THEREFOR

(71) Applicant: LG ELECTRONICS INC., Seoul (KR)

(72) Inventors: Kyuhwan KWAK, Seoul (KR); Suckchel YANG, Seoul (KR); Daesung HWANG, Seoul (KR); Seonwook KIM, Seoul (KR)

(21) Appl. No.: 16/323,139

(22) PCT Filed: Aug. 7, 2017
(86) PCT No.: PCT/KR2017/008522

§ 371 Date: Feb. 4, 2019

Related U.S. Application Data
(60) Provisional application No. 62/371,225, filed on Aug. 5, 2016.
(60) Provisional application No. 62/379,231, filed on Aug. 24, 2016.

(51) Int. Cl. H04W 72/12; H04B 1/713; H04L 25/02; H04L 27/26

(52) U.S. Cl. CPC H04W 72/1284; H04W 72/1268; H04L 27/2607; H04L 25/0224; H04B 1/713

(57) ABSTRACT

The present invention discloses a method for transmitting a scheduling request and a device therefor in a wireless communication system. More specifically, the method performed by a user equipment (UE) includes receiving, from a base station, sounding reference signal (SRS) configuration information related to SRS transmission, and transmitting, to the base station, at least one SRS indicating a specific SR of a plurality of SRs based on the SRS configuration information. The SRS configuration information includes at least one of cyclic shift (CS) index information of a sequence related to the SRS transmission, comb information representing a comb structure in which the sequence is transmitted, or hopping bandwidth information related to the SRS transmission. The specific SR is indicated according to at least one of an CS index selected based on the CS index information, a comb index selected based on the comb information, or a hopping pattern based on the hopping bandwidth information.

### CROSS-REFERENCE TO RELATED APPLICATIONS

This application is the National Stage filing under 35 U.S.C. 371 of International Application No. PCT/KR2017/008522, filed on Aug. 7, 2017, which claims the benefit of U.S. Provisional Application No. 62/371,225, filed on Aug. 5, 2016, and No. 62/379,231, filed on Aug. 24, 2016, the contents of which are all hereby incorporated by reference herein in their entirety.

### TECHNICAL FIELD

The present specification relates to a wireless communication system, and more particularly to a method for transmitting a specific scheduling request in a system supporting one or more scheduling requests and a device supporting the same.

### TECHNICAL FIELD

Mobile communication systems have been developed to provide voice services while ensuring the activity of a user. However, the mobile communication systems have been expanded to their regions up to data services as well as voice. Today, the shortage of resources is caused due to an explosive increase of traffic, and more advanced mobile communication systems are required due to user's need for higher speed services.

Requirements for a next-generation mobile communication system basically include the acceptance of explosive data traffic, a significant increase of a transfer rate per user, the acceptance of the number of significantly increased connection devices, very low end-to-end latency, and high energy efficiency. To this end, research is carried out on various technologies, such as dual connectivity, massive Multiple Input Multiple Output (MIMO), in-band full duplex, Non-Orthogonal Multiple Access (NOMA), the support of a super wideband, and device networking.

### DISCLOSURE

### Technical Problem

The present specification proposes a method for transmitting, by a user equipment (UE), a scheduling request (SR) in a wireless communication system.

The present specification proposes a method for transmitting, by a UE, a specific scheduling request in a NR system supporting a plurality of SR types.

More specifically, the present specification proposes a method for periodically transmitting a SR and a method for aperiodically transmitting a SR.

The present specification also proposes, in relation to a method for periodically transmitting a SR, a method for transmitting a SR using an uplink control channel resource and a method for transmitting a SR in a subframe for transmission of a random access channel.

The present specification also proposes, in relation to a method for aperiodically transmitting a SR, a method for transmitting a SR together with transmission of an uplink control channel and a method for transmitting a SR using a sounding reference signal.

Technical problems to be solved by the present invention are not limited by the above-mentioned technical problems, and other technical problems which are not mentioned above can be clearly understood from the following description by those skilled in the art to which the present invention pertains.

### Technical Solution

The present specification proposes a method for transmitting, by a user equipment (UE), a scheduling request (SR) in a wireless communication system. The method comprises receiving, from a base station, sounding reference signal (SRS) configuration information related to SRS transmission, and transmitting, to the base station, at least one SRS related to a specific SR of a plurality of SRs based on the SRS configuration information, wherein the SRS configuration information includes at least one of cyclic shift (CS) index information of a sequence related to the SRS transmission, comb information representing a comb structure in which the sequence is transmitted, or hopping bandwidth information related to the SRS transmission, and wherein the specific SR is indicated according to at least one of an CS index selected based on the CS index information, a comb index selected based on the comb information, or a hopping pattern based on the hopping bandwidth information.

In the present specification, the plurality of SRs may include at least one of a SR related to resource allocation for data or a SR for requesting a scheduling related to a beam.

In the present specification, the SR for requesting the scheduling related to the beam may include at least one of a SR for requesting a beam change or a SR for requesting an initiation of a reference signal related to beam refinement.

In the present specification, the CS index information may include at least one of a first CS index group or a second CS index group, the first CS index group may represent the SR related to the resource allocation for the data, and the second CS index group may represent the SR for requesting the scheduling related to the beam.

In the present specification, the second CS index group may include at least one of a first CS index subgroup or a second CS index subgroup, the first CS index subgroup may represent a SR for requesting a beam change, and the second CS index subgroup may represent a SR for requesting an initiation of a reference signal related to beam refinement.

In the present specification, the comb information may include a first comb index and a second comb index, the first comb index may represent the SR related to the resource allocation for the data, and the second comb index may represent the SR for requesting the scheduling related to the beam.

In the present specification, wherein the first comb index may represent an even comb structure consisting of indexes of even-numbered subcarriers, and the second comb index may represent an odd comb structure consisting of indexes of odd-numbered subcarriers.

In the present specification, when the SR related to the resource allocation for the data includes at least one of a first SR or a second SR, a first CS index and a second CS index among CS indexes corresponding to the first comb index may represent the first SR and the second SR, respectively. When the SR for requesting the scheduling related to the beam includes at least one of a third SR or a fourth SR, a third CS index and a fourth CS index among CS indexes corresponding to the second comb index may represent the third SR and the fourth SR, respectively.

In the present specification, the hopping bandwidth information may include information about one or more subbands included in a bandwidth allocated for the SRS transmission, and the hopping pattern may represent an order of the one or more subbands on which the at least one SRS is transmitted.

In the present specification, the hopping pattern may include at least one of a first hopping pattern group or a second hopping pattern group that are determined according to the order, the first hopping pattern group may represent the SR related to the resource allocation for the data, and the second hopping pattern group may represent the SR for requesting the scheduling related to the beam.

In the present specification, the sequence may include at least one of a Zadoff-Chu sequence or a pseudo-random sequence.

In the present specification, the SRS configuration information may be received via at least one of higher layer signaling or downlink control information.

The present specification proposes a user equipment (UE) for transmitting a scheduling request (SR) in a wireless communication system. The UE comprises a transceiver configured to transmit and receive a radio signal, and a processor functionally coupled to the transceiver, wherein the processor is controlled to receive, from a base station, sounding reference signal (SRS) configuration information related to SRS transmission, and transmit, to the base station, at least one SRS related to a specific SR of a plurality of SRs based on the SRS configuration information, wherein the SRS configuration information includes at least one of cyclic shift (CS) index information of a sequence related to the SRS transmission, comb information representing a comb structure in which the sequence is transmitted, or hopping bandwidth information related to the SRS transmission, and wherein the specific SR is indicated according to at least one of an CS index selected based on the CS index information, a comb index selected based on the comb information, or a hopping pattern based on the hopping bandwidth information.

### Advantageous Effects

According to embodiments of the present invention, a UE can distinguish and transmit one or more scheduling request (SR) types in a NR system supporting various types of SRs, unlike existing legacy LTE system.

According to embodiments of the present invention, a UE can transmit a SR as well as a preamble of a random access purpose in a subframe (e.g., PRACH subframe) allocated for a random access procedure.

According to embodiments of the present invention, a separate procedure for SR transmission and resource allocation can be omitted by implicitly transmitting a specific type of SR through transmission of a sounding reference signal.

Effects obtainable from the present invention are not limited by the effects mentioned above, and other effects which are not mentioned above can be clearly understood from the following description by those skilled in the art to which the present invention pertains.

### DESCRIPTION OF DRAWINGS

The accompany drawings, which are included to provide a further understanding of the present invention and are incorporated on and constitute a part of this specification illustrate embodiments of the present invention and together with the description serve to explain the principles of the present invention.

FIG. 1 illustrates an example of an overall structure of a NR system to which a method proposed by the present specification is applicable.

FIG. 2 illustrates a relation between an uplink frame and a downlink frame in a wireless communication system to which a method proposed by the present specification is applicable.

FIG. 3 illustrates an example of a resource grid supported in a wireless communication system to which a method proposed by the present specification is applicable.

FIG. 4 illustrates examples of resource grids for each antenna port and numerology to which a method proposed by the present specification is applicable.

FIG. 5 illustrates an example of a self-contained subframe (or slot) structure to which a method proposed by the present specification is applicable.

FIG. 6 illustrates examples of a self-contained subframe (or slot) structure to which a method proposed by the present specification is applicable.

FIG. 7 illustrates a method for receiving, by a base station, a random access channel (RACH) from a plurality of UEs.

FIG. 8 illustrates an example of an uplink control channel structure applicable to a NR system.

FIG. 9 illustrates an example of a method for transmitting a SR using a sounding reference signal (SRS) to which a method proposed by the present specification is applicable.

FIG. 10 illustrates another example of a method for transmitting a SR using a SRS to which a method proposed by the present specification is applicable.

FIG. 11 illustrates an operation flow chart of a UE for transmitting a scheduling request (SR) to which a method proposed by the present specification is applicable.

FIG. 12 illustrates a block configuration diagram of a wireless communication device to which methods proposed by the present specification are applicable.

FIG. 13 illustrates a block configuration diagram of a communication device according to an embodiment of the present invention.

### MODE FOR INVENTION

Hereinafter, preferred embodiments of the present invention will be described in detail with reference to the accompanying drawings. A detailed description to be disclosed below together with the accompanying drawing is to describe embodiments of the present invention and not to describe a unique embodiment for carrying out the present invention. The detailed description below includes details in order to provide a complete understanding. However, those skilled in the art know that the present invention can be carried out without the details.

In some cases, in order to prevent a concept of the present invention from being ambiguous, known structures and devices may be omitted or may be illustrated in a block diagram format based on core function of each structure and device.

In the specification, a base station means a terminal node of a network directly performing communication with a terminal. In the present document, specific operations described to be performed by the base station may be performed by an upper node of the base station in some cases. That is, it is apparent that in the network constituted by multiple network nodes including the base station, various operations performed for communication with the terminal may be performed by the base station or other network nodes other than the base station. A base station (BS) may be generally substituted with terms such as a fixed station, Node B, evolved-NodeB (eNB), a base transceiver system (BTS), an access point (AP), and the like. Further, a ‘terminal’ may be fixed or movable and be substituted with terms such as user equipment (UE), a mobile station (MS), a user terminal (UT), a mobile subscriber station (MSS), a subscriber station (SS), an advanced mobile station (AMS), a wireless terminal (WT), a Machine-Type Communication (MTC) device, a Machine-to-Machine (M2M) device, a Device-to-Device (D2D) device, and the like.

Hereinafter, a downlink means communication from the base station to the terminal and an uplink means communication from the terminal to the base station. In the downlink, a transmitter may be a part of the base station and a receiver may be a part of the terminal. In the uplink, the transmitter may be a part of the terminal and the receiver may be a part of the base station.

Specific terms used in the following description are provided to help appreciating the present invention and the use of the specific terms may be modified into other forms within the scope without departing from the technical spirit of the present invention.

The following technology may be used in various wireless access systems, such as code division multiple access (CDMA), frequency division multiple access (FDMA), time division multiple access (TDMA), orthogonal frequency division multiple access (OFDMA), single carrier-FDMA (SC-FDMA), non-orthogonal multiple access (NOMA), and the like. The CDMA may be implemented by radio technology universal terrestrial radio access (UTRA) or CDMA2000. The TDMA may be implemented by radio technology such as global system for mobile communications (GSM)/general packet radio service (GPRS)/enhanced data rates for GSM Evolution (EDGE). The OFDMA may be implemented as radio technology such as IEEE 802.11 (Wi-Fi), IEEE 802.16 (WiMAX), IEEE 802-20, E-UTRA (Evolved UTRA), and the like. The UTRA is a part of a universal mobile telecommunication system (UMTS). 3rd generation partnership project (3GPP) long term evolution (LTE) as a part of an evolved UMTS (E-UMTS) using evolved-UMTS terrestrial radio access (E-UTRA) adopts the OFDMA in a downlink and the SC-FDMA in an uplink. LTE-advanced (A) is an evolution of the 3GPP LTE.

The embodiments of the present invention may be based on standard documents disclosed in at least one of IEEE 802, 3GPP, and 3GPP2 which are the wireless access systems. That is, steps or parts which are not described to definitely show the technical spirit of the present invention among the embodiments of the present invention may be based on the documents. Further, all terms disclosed in the document may be described by the standard document.

3GPP LTE/LTE-A/New RAT (NR) is primarily described for clear description, but technical features of the present invention are not limited thereto.

As the supply of smartphones and Internet of Things (IoT) UEs is rapidly spread, the amount of information exchanged over a communication network is explosively increased. Accordingly, in a next-generation radio access technology, an environment (e.g., enhanced mobile broadband communication) that provides users with faster services than the existing communication system (or existing radio access technology) may need to be taken into consideration. To this end, the design of a communication system in which machine type communication (MTC) providing services by connecting multiple devices and objects is also taken into consideration.

Furthermore, the design of a communication system (e.g., ultra-reliable and low latency communication URLLC) in which reliability of communication and/or service and/or a terminal, etc. sensitive to latency is taken into consideration is also discussed.

In the following specification, for convenience of description, a next-generation radio access technology is referred to as a new RAT (NR, radio access technology). A wireless communication system to which the NR is applied is referred to as an NR system.

### Definition of Terms

eLTE eNB: An eLTE eNB is an evolution of an eNB that supports connectivity to an EPC and an NGC.

gNB: A node for supporting NR in addition to connectivity with an NGC.

New RAN: A radio access network that supports NR or E-UTRA or interacts with an NGC.

Network slice: A network slice is a network defined by an operator so as to provide a solution optimized for a specific market scenario that requires a specific requirement together with an inter-terminal range.

Network function: A network function is a logical node in a network infra that has a well-defined external interface and a well-defined functional operation.

NG-C: A control plane interface used for NG2 reference point between new RAN and an NGC.

NG-U: A user plane interface used for NG3 reference point between new RAN and an NGC.

Non-standalone NR: A deployment configuration where a gNB requires an LTE eNB as an anchor for control plane connectivity to an EPC or requires an eLTE eNB as an anchor for control plane connectivity to an NGC.

Non-standalone E-UTRA: A deployment configuration where an eLTE eNB requires a gNB as an anchor for control plane connectivity to an NGC.

User plane gateway: A terminal point of NG-U interface.

General System

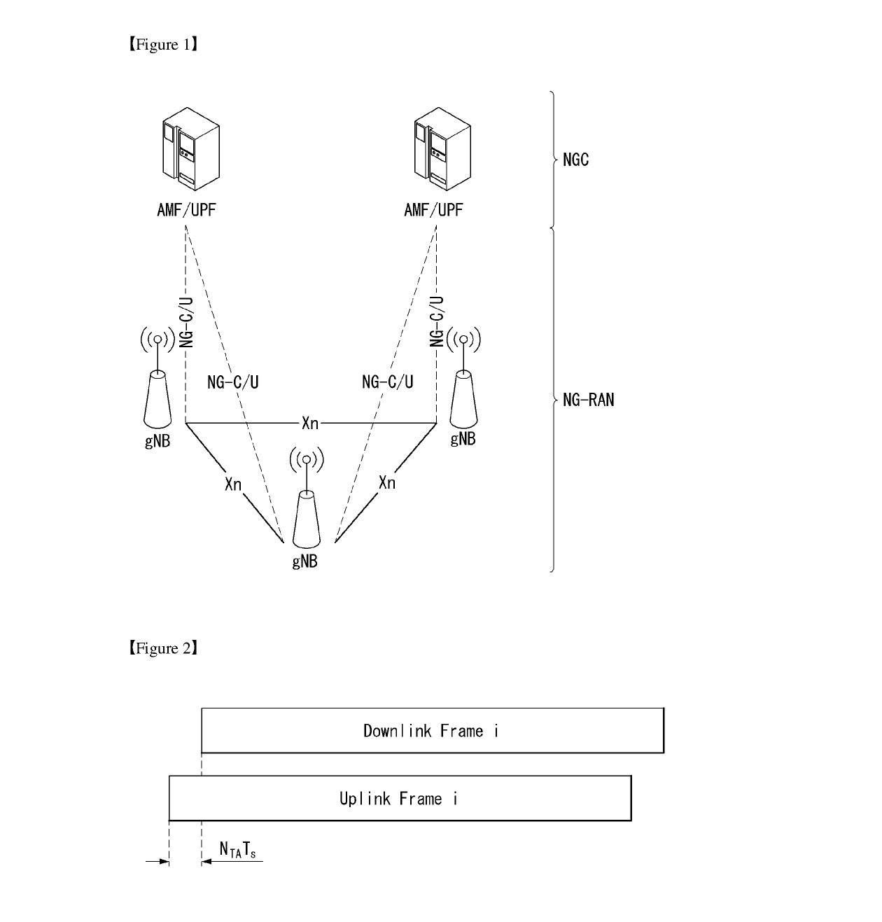

FIG. 1 illustrates an example of an overall structure of a NR system to which a method proposed by the present specification is applicable.

Referring to FIG. 1, an NG-RAN is composed of gNB (gNodeB, next generation NodeB) that provide an NG-RA user plane (new AS sublayer/PDCP/RLC/MAC/PHY) and a control plane (RRC) protocol terminal for a UE (User Equipment).

The gNBs are connected to each other via an Xₙ interface.

The gNBs are also connected to an NGC via an NG interface.

More specifically, the gNBs are connected to a Access and Mobility Management Function (AMF) via an N2 interface and a User Plane Function (UPF) via an N3 interface.

New Rat (NR) Numerology and Frame Structure

In a NR system, multiple numerologies can be supported. The numerologies may be defined by subcarrier spacing and cyclic prefix (CP) overhead. Spacing between multiple subcarriers may be derived by scaling basic subcarrier spacing into an integer N (or μ). In addition, even if a very low subcarrier spacing is assumed not to be used at a very high subcarrier frequency, a numerology to be used may be selected independent of a frequency band.

In addition, in the NR system, a variety of frame structures according to multiple numerologies can be supported.

Hereinafter, an orthogonal frequency division multiplexing (OFDM) numerology and a frame structure, which may be considered in the NR system, will be described.

A plurality of OFDM numerologies supported in the NR system may be defined as in Table 1.

TABLE 1

| μ | Δf = 2^{μ} · 15 [kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |

In regard to a frame structure in the NR system, a size of various fields in a time domain is expressed as a multiple of a time unit of Tₛ=1/(Δfₘₐₓ·N_{f}). Here, Δfₘₐₓ=480·10³ and N_{f}=4096. Downlink and uplink transmissions are organized into radio frames having a duration of T_{f}=(ΔfₘₐₓN_{f}/100)·Tₛ=10 ms. The radio frame consists of ten subframes each having a duration of T_{sf}=(ΔfₘₐₓN_{f}/1000)·Tₛ=1 ms. In this case, there may be one set of frames in the uplink and one set of frames in the downlink.

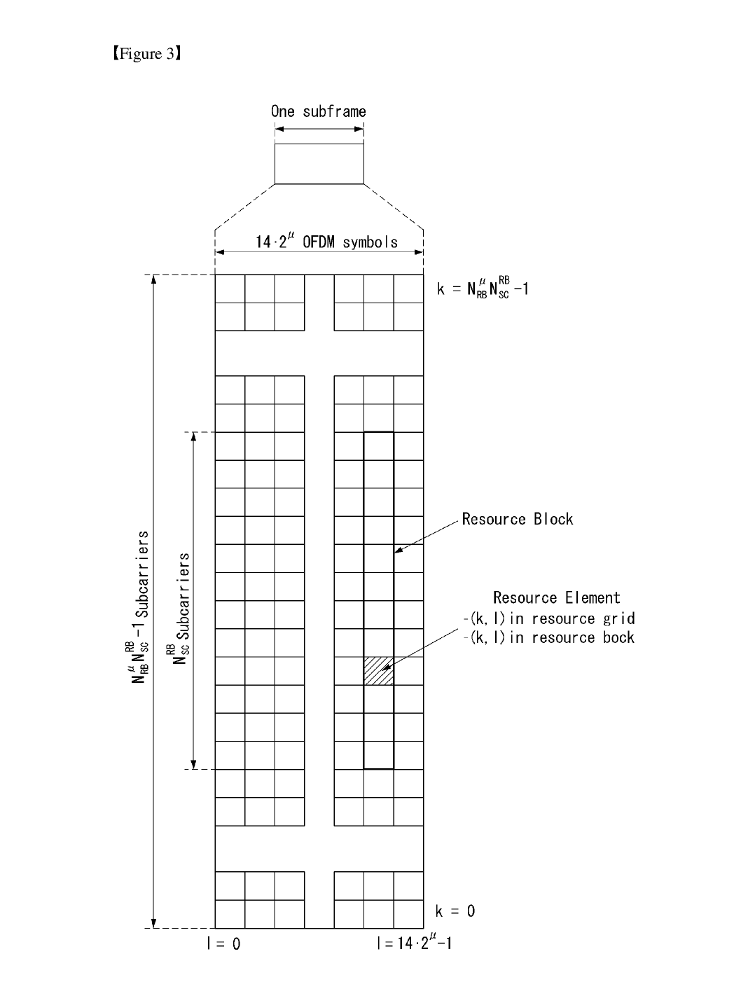

FIG. 2 illustrates a relation between an uplink frame and a downlink frame in a wireless communication system to which a method proposed by the present specification is applicable.

As illustrated in FIG. 2, the transmission of an uplink frame number i from a user equipment (UE) needs to start T_{TA}=N_{TA}Tₛ before the start of a corresponding downlink frame at the UE.

Regarding the numerology μ, slots are numbered in increasing order of nₛ^{μ}∈{0, . . . , N_{subframe}^{slots,μ}−1} in a subframe and are numbered in increasing order of n_{s,f}^{μ}∈{0, . . . , N_{subframe}^{slots,μ}−1} in a radio frame. One slot is composed of consecutive OFDM symbols of N_{symb}^{μ}, and N_{symb}^{μ} is determined depending on a numerology in use and slot configuration. The start of slots nₛ^{μ} in a subframe is aligned in time with the start of OFDM symbols nₛ^{μ}N_{symb}^{μ} in the same subframe.

Not all UEs are able to transmit and receive at the same time, and this means that not all OFDM symbols in a downlink slot or an uplink slot are available to be used.

Table 2 shows the number of OFDM symbols per slot for a normal CP in the numerology μ, and Table 3 shows the number of OFDM symbols per slot for an extended CP in the numerology μ.

TABLE 2

| | Slot configuration | | | | | |
|---|---|---|---|---|---|---|
| | 0 | | | 1 | | |
| μ | N_{symb}^{μ} | N_{frame}^{slots,μ} | N_{subframe}^{slots,μ} | N_{symb}^{μ} | N_{frame}^{slots,μ} | N_{subframe}^{slots,μ} |
| 0 | 14 | 10 | 1 | 7 | 20 | 2 |
| 1 | 14 | 20 | 2 | 7 | 40 | 4 |
| 2 | 14 | 40 | 4 | 7 | 80 | 8 |
| 3 | 14 | 80 | 8 | — | — | — |
| 4 | 14 | 160 | 16 | — | — | — |
| 5 | 14 | 320 | 32 | — | — | — |

TABLE 3

| | Slot configuration | | | | | |
|---|---|---|---|---|---|---|
| | 0 | | | 1 | | |
| μ | N_{symb}^{μ} | N_{frame}^{slots,μ} | N_{subframe}^{slots,μ} | N_{symb}^{μ} | N_{frame}^{slots,μ} | N_{subframe}^{slots,μ} |
| 0 | 12 | 10 | 1 | 6 | 20 | 2 |
| 1 | 12 | 20 | 2 | 6 | 40 | 4 |
| 2 | 12 | 40 | 4 | 6 | 80 | 8 |
| 3 | 12 | 80 | 8 | — | — | — |
| 4 | 12 | 160 | 16 | — | — | — |
| 5 | 12 | 320 | 32 | — | — | — |

NR Physical Resource

In regard to physical resources in the NR system, an antenna port, a resource grid, a resource element, a resource block, a carrier part, etc. may be considered.

Hereinafter, the above physical resources possible to be considered in the NR system will be described in more detail.

First, in regard to an antenna port, the antenna port is defined such that a channel over which a symbol on an antenna port is conveyed can be inferred from a channel over which another symbol on the same antenna port is conveyed. When large-scale properties of a channel over which a symbol on one antenna port is conveyed can be inferred from a channel over which a symbol on another antenna port is conveyed, the two antenna ports may be said to be in a quasi co-located or quasi co-location (QC/QCL) relation. Here, the large-scale properties may include at least one of delay spread, Doppler spread, frequency shift, average received power, and received timing.

FIG. 3 illustrates an example of a resource grid supported in a wireless communication system to which a method proposed by the present specification is applicable.

Referring to FIG. 3, a resource grid consists of N_{RB}^{μ}N_{sc}^{RB} subcarriers on a frequency domain, each subframe consisting of 14·2μ OFDM symbols, but the present invention is not limited thereto.

In the NR system, a transmitted signal is described by one or more resource grids, consisting of N_{RB}^{μ}N_{sc}^{RB} subcarriers, and 2^{μ}N_{symb}^{(μ)} OFDM symbols. Here, N_{RB}^{μ}≤N_{RB}^{max,μ}. The N_{RB}^{max,μ} represents a maximum transmission bandwidth and may change not only between numerologies but also between uplink and downlink.

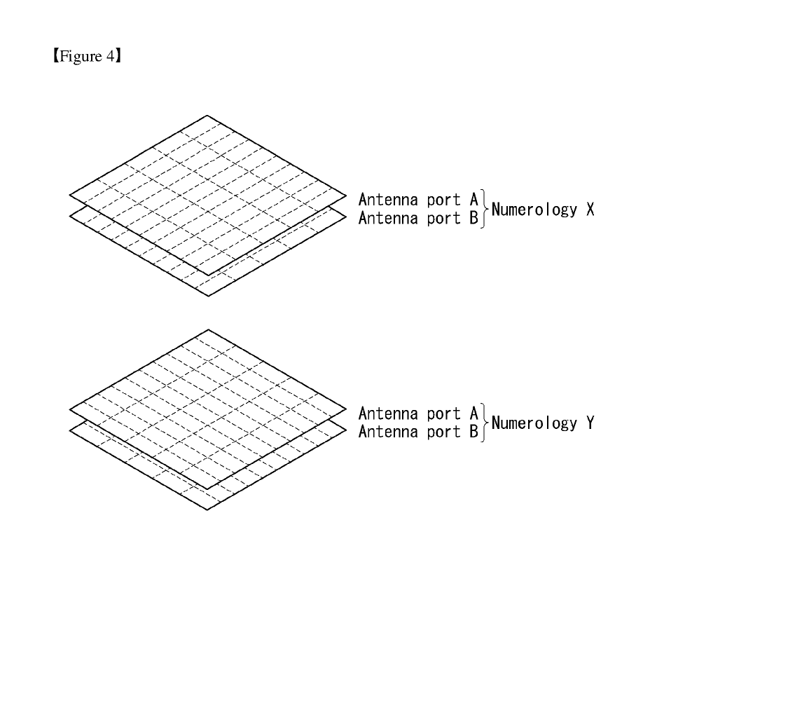

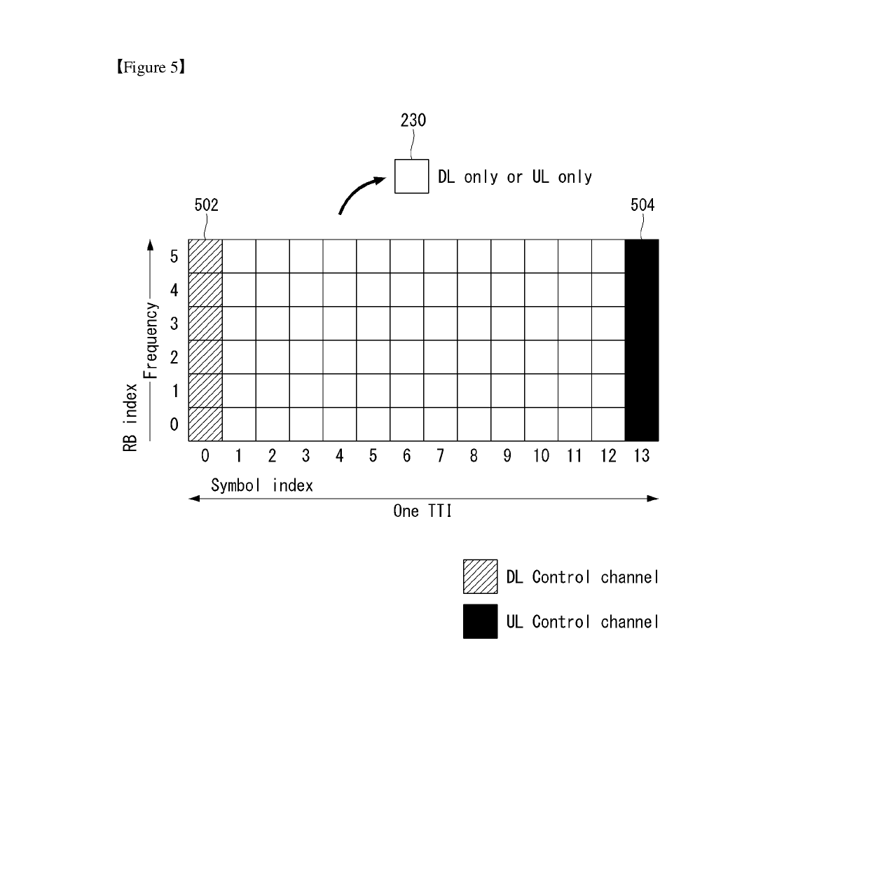

In this case, as illustrated in FIG. 4, one resource grid may be configured per the numerology μ and an antenna port p.

FIG. 4 illustrates examples of resource grids for each antenna port and numerology to which a method proposed by the present specification is applicable.

Each element of the resource grid for the numerology μ and the antenna port p is called a resource element and is uniquely identified by an index pair (k,l̅), where k=0, . . . , N_{RB}^{μ}N_{sc}^{RB}−1 is an index in a frequency domain, and l̅=0, . . . , 2^{μ}N_{symb}^{(μ)}−1 refers to a location of a symbol on a subframe. The index pair (k,l̅) is used to refer to a resource element in a slot, where l=0, . . . , N_{symb}^{μ}−1.

The resource element (k,l̅) for the numerology μ and the antenna port p corresponds to a complex value a_{k,l̅}^{(p,μ)}. When there is no risk for confusion or when a specific antenna port or numerology is not specified, the indexes p and μ may be dropped, and as a result, the complex value may be a_{k,l̅}^{(p)} or a_{k,l̅}.

In addition, a physical resource block is defined as N_{sc}^{RB}=12 consecutive subcarriers in the frequency domain. On the frequency domain, physical resource blocks are numbered from 0 to N_{RB}^{μ}−1. A relation between a physical resource block number n_{PRB} in the frequency domain and the resource elements (k,l) may be given by Equation 1.

$${n}_{PRB} = ⌊ \frac{k}{{N}_{sc}^{RB}} ⌋ \qquad [ Equation 1 ]$$

In regard to a carrier part, a UE may be configured to receive or transmit the carrier part using only a subset of a resource grid. In this instance, a set of resource blocks which the UE is configured to receive or transmit are numbered from 0 to N_{URB}^{μ}−1 in the frequency domain.

Self-Contained Subframe (or Slot) Structure

A time division duplexing (TDD) structure considered in the NR system is a structure in which both uplink (UL) and downlink (DL) are processed in one subframe. The structure is to minimize a latency of data transmission in a TDD system and is called a self-contained subframe structure or a self-contained slot structure.

FIG. 5 illustrates an example of a self-contained subframe (or slot) structure to which a method proposed by the present specification is applicable. FIG. 5 is merely for convenience of explanation and does not limit the scope of the present invention.

Referring to FIG. 5, as in legacy LTE, it is assumed that one subframe is composed of 14 orthogonal frequency division multiplexing (OFDM) symbols.

In FIG. 5, a region 502 means a downlink control region, and a region 504 means an uplink control region. Further, regions (i.e., regions without separate indication) other than the region 502 and the region 504 may be used for transmission of downlink data or uplink data.

That is, uplink control information and downlink control information are transmitted in one self-contained subframe (or slot). On the other hand, in case of data, uplink data or downlink data is transmitted in one self-contained subframe (or slot).

When the structure illustrated in FIG. 5 is used, in one self-contained subframe (or slot), downlink transmission and uplink transmission may sequentially proceed, and downlink data transmission and uplink ACK/NACK reception may be performed.

As a result, if an error occurs in the data transmission, time required until retransmission of data can be reduced. Hence, the latency related to data transfer can be minimized.

In the self-contained subframe (or slot) structure illustrated in FIG. 5, a base station (e.g., eNodeB, eNB, gNB) and/or a user equipment (UE) (e.g., terminal) require a time gap for a process for converting a transmission mode into a reception mode or a process for converting a reception mode into a transmission mode. In regard to the time gap, when uplink transmission is performed after downlink transmission in the self-contained subframe (or slot), some OFDM symbol(s) may be configured as a guard period (GP).

In the NR system, self-contained subframe (or slot) structures of several types may be considered in addition to the structure illustrated in FIG. 5.

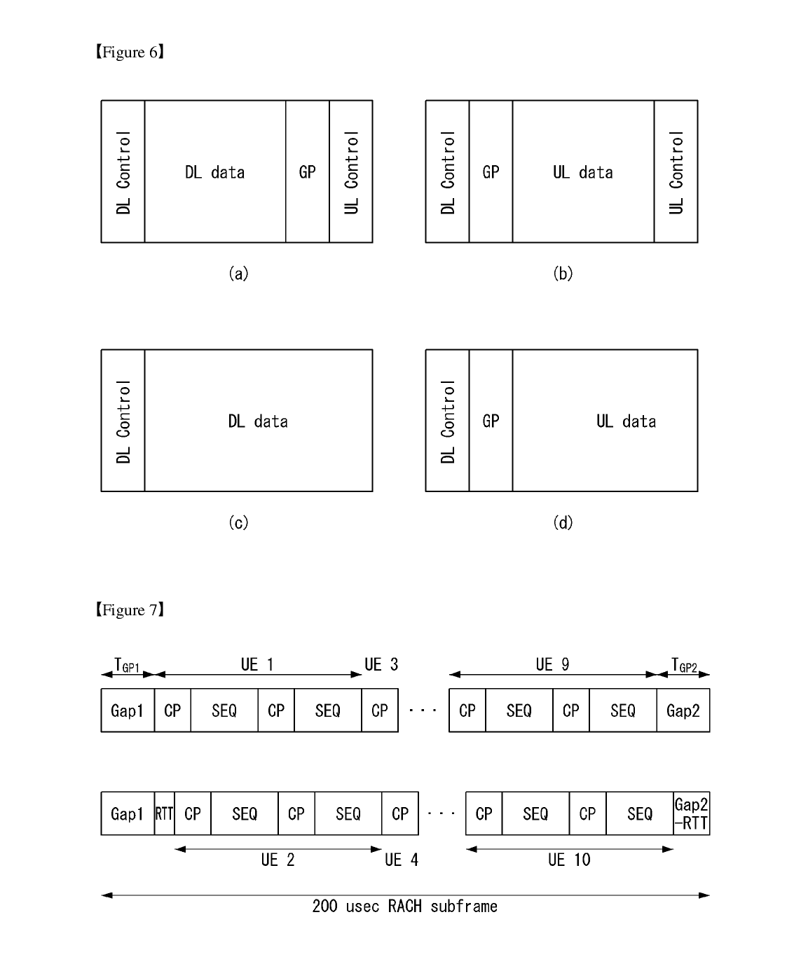

FIG. 6 illustrates examples of a self-contained subframe (or slot) structure to which a method proposed by the present specification is applicable. FIG. 6 is merely for convenience of explanation and does not limit the scope of the present invention.

As shown in (a) to (d) of FIG. 6, a self-contained subframe (or slot) in the NR system may be configured in various combinations using a DL control region, a DL data region, a guard period (GP), an UL control region, and/or an UL data region as one unit.

Uplink Control Channel

Physical uplink control signaling should be able to at least carry hybrid-ARQ acknowledgment, CSI report (including beamforming information if possible), and a scheduling request.

At least two transmission methods are supported for the UL control channel supported by the NR system.

The uplink control channel may be transmitted around a last transmitted uplink symbol(s) of a slot in short duration. In this case, the uplink control channel is time-division-multiplexed and/or frequency-division-multiplexed with an uplink (UL) data channel in the slot. One-symbol unit transmission of the slot is supported with respect to the uplink control channel of the short duration.
Short uplink control information (UCI) and data are frequency-division-multiplexed at least between the UE and the UE in the case where the physical resource blocks (PRBs) for the short UCI and the data do not overlap.
In order to support time division multiplexing (TDM) of short PUCCH from different UEs in the same slot, a mechanism for notifying to the UE whether the symbol(s) in the slot to transmit the short PUCCH is supported at least at 6 GHz or more is supported.
With respect to 1-symbol duration, supported at least are 1) that when a reference signal (RS) is multiplexed, the UCI and the RS is multiplexed to a given OFDM symbol by a frequency division multiplexing (FDM) scheme and 2) that subcarrier spacings between downlink (DL) and uplink (UL) data and the short duration PUCCH are the same as each other in the same slot.
At least, the short duration PUCCH during 2-symbol duration is supported. In this case, the subcarrier spacings between the downlink (DL) and uplink (UL) data and the short duration PUCCH are the same as each other in the same slot.
At least, a semi-static configuration is supported, in which a PUCCH resource of the UE given in the slot, that is, short PUCCHs of different UEs may be time-division-multiplexed within given duration.
The PUCCH resource includes a time domain and a frequency domain and if applicable, the PUCCH resource includes a code domain.
The short duration PUCCH may be extended to the end of the slot from the viewpoint of the UE. In this case, after the short duration PUCCH, an explicit gap symbol is not required.
In regard to a slot (that is, a DL-centric slot) having a short UL part, when data is scheduled in a short uplink part, ‘short UCI’ and data may be frequency-division-multiplexed by one UE.

The uplink control channel may be transmitted over multiple uplink symbols during long duration in order to improve coverage. In this case, the uplink control channel is frequency-division-multiplexed with the uplink data channel in the slot.
At least, a UCI carried by a long duration UL control channel may be transmitted in one slot or multiple slots by a design with a low peak to average power ratio (PAPR).
Transmission using multiple slots is allowed for a total duration (e.g., 1 ms) in at least some cases.
For the long duration uplink control channel, time division multiplexing (TDM) between the RS and the UCI is supported with respect to DFT-S-OFDM.
The long UL part of the slot may be used for transmitting the long duration PUCCH. That is, the long duration PUCCH is supported with respect to both a UL-only slot and a slot having symbols of a variable number constituted by a minimum of four symbols.
At least with respect to a 1 or 2-bit UCI, the UCI may be repeated in N (N>1) slots and the N slots may be adjacent or not adjacent in slots in which the long duration PUCCH is allowed.
At least, simultaneously transmission of the PUSCH and the PUCCH is supported with respect to a long PUCCH. That is, even when there is data, the uplink control for the PUCCH resource is transmitted. Further, in addition to the simultaneous transmission of the PUCCH and the PUSCH, the UCI in the PUSCH is supported.
Intra-TTI slot frequency hopping is supported.
A DFT-s-OFDM waveform is supported.
A transmit antenna diversity is supported.

TDM and FDM between the short duration PUCCH and the long duration PUCCH are supported for other UEs in at least one slot. In the frequency domain, the PRB (or multiple PRBs) is the minimum resource unit size for the UL control channel. When hopping is used, frequency resources and hopping may not spread to a carrier bandwidth. Further, a UE-specific RS is used for NR-PUCCH transmission. A set of PUCCH resources is configured by higher layer signaling and the PUCCH resources within the configured set is indicated by downlink control information (DCI).

As part of the DCI, the timing between data reception and hybrid-ARQ acknowledgment transmission should be dynamically (at least together with RRC) indicated. A combination of the semi-static configuration and dynamic signaling (for at least some types of UCI information) is used to determine the PUCCH resource for ‘long and short PUCCH formats’. Here, the PUCCH resource includes the time domain and the frequency domain and, if applicable, the PUCCH resource includes the code domain. Using UCI on the PUSCH, that is, a part of the scheduled resource for the UCI is supported in the case of simultaneous transmission of the UCI and the data.

Further, at least a single HARQ-ACK bit uplink transmission is supported at least. In addition, a mechanism is supported, which enables the frequency diversity. Further, in the case of Ultra-Reliable and Low-Latency Communication (URLLC), a time interval between scheduling (SR) resources configured for the UE may be smaller than one slot.

x-Physical Uplink Control Channel (PUCCH) Format

(1) Physical Uplink Control Channel (xPUCCH)

The physical uplink control channel, i.e., xPUCCH, carries the uplink control information. The xPUCCH may be transmitted in a last symbol of the subframe.

All xPUCCH formats adopts cyclic shift and n_{cs}^{cell}(nₛ). Here, the cyclic shift is changed by slot number nₛ. The cyclic shift is defined according to Equation 2.

n_{cs}^{cell}(nₛ)=Σᵢ₌₀⁷c(8N_{symb}^{UL}·n̅ₛ+i)·2ⁱ

n̅ₛ=nₛ mod 20 [Equation 2]

In Equation 2, c(i) denotes the pseudo-random sequence and a pseudo-random sequence generator is initialized by cᵢₙᵢₜ=n_{ID}^{RS}.

The physical uplink control channel supports multiple formats as shown in Table 4.

TABLE 4

| xPUCCH | Modulation | Number of bits per |
|---|---|---|
| format | scheme | subframe, M_{bit} |
| 1 | N/A | N/A |
| 1a | BPSK | 1 |
| 1b | QPSK | 2 |
| 2 | QPSK | 96 |

(2) xPUCCH Formats 1, 1a, and 1b

For xPUCCH format 1, information is carried by presence/absence of the transmission of the xPUCCH from the UE. For xPUCCH format 1, d (0)=1 is assumed.

For each of xPUCCH formats 1a and 1b, one or two explicit bits are transmitted. Blocks b(0), . . . , b(M_{bit}−1) of bits are modulated as described in Table 2, resulting in a complex-valued symbol d(0). Modulation schemes for other xPUCCH formats are given in Table 5.

TABLE 5

| PUCCH | | |
|---|---|---|
| format | b(0), . . . , b(M_{bit} − 1) | d(0) |
| 1a | 0 | 1 |
| | 1 | −1 |
| 1b | 00 | 1 |
| | 01 | −j |
| | 10 | j |
| | 11 | −1 |

The complex-valued symbol d(0) is multiplexed into a sequence of cyclically shifted lengths N_{seq}^{PUCCH}=48 for each of P antenna ports used for xPUCCH transmission according to Equation 3.

$${y}^{( \tilde{p} )} ( n ) = \frac{1}{\sqrt{P}} d ( 0 ) \cdot {r}_{u , v}^{( {α}_{\tilde{p}} )} ( n ) , n = 0 , 1 , … , {N}_{seq}^{PUCCH} - 1 \qquad [ Equation 3 ]$$

In Equation 3, r_{u,v}^{(α}^{_{\tilde{p}}}⁾(n) is defined as M_{sc}^{RB}=N_{seq}^{PUCCH} and an antenna port specific cyclic shift is defined by Equation 4.

$$\begin{matrix}{α}_{\tilde{p}} ( {n}_{s} ) = 2 π \cdot {n}_{cs}^{( \tilde{p} )} ( {n}_{s} ) / {N}_{sc}^{RB} \\ {n}_{cs}^{\tilde{p}} ( {n}_{s} ) = [ {n}_{cs}^{cell} ( {n}_{s} ) = {n}_{CS}^{xPUCCH , 1} + \frac{{N}_{sc}^{RB} \tilde{p}}{P} ] mod {N}_{sc}^{RB} \\ \tilde{p} ∈ \{ 0 , 1 , … , P - 1 \}\end{matrix} \qquad [ Equation 4 ]$$

In Equation 4, n_{cs}^{xPUCCH}∈{0,2,3,4,6,8,9,10} is configured by higher layers.

The block y of the complex-valued symbols is mapped to z according to Equation 5.

z^{(\tilde{p})}(n_{xPUCCH}⁽¹⁾·N_{xPUCCH}^{RB}·N_{RB}^{RB}+m·N_{sc}^{RB}+k′)=y^{(\acute{p})}(8·m′+k) [Equation 5]

In Equation 5, k′, m′, and N_{xPUCCH}^{RB} are as the following Equation 6.

$$\begin{matrix}{k}^{′} = \{ \begin{matrix}k & 0 \leq k \leq 1 \\ k + 2 & 2 \leq k \leq 5 \\ k + 4 & 6 \leq k \leq 7\end{matrix} \\ {m}^{′} = 0 , 1 , 2 , … , 5 \\ {N}_{xPUCCH}^{RB} = 6\end{matrix} \qquad [ Equation 6 ]$$

The resources used for transmission of the xPUCCH formats 1, 1a, and 1b are identified by a resource index n_{xPUCCH}⁽¹⁾, and n_{xPUCCH}⁽¹⁾ is configured by the higher layers and indicated on the x-Physical Downlink Control Channel (xPDCCH).

(3) xPUCCH Format 2

The block b(0), . . . , b(M_{bit}−1) of bits are scrambled by a UE-specific scrambling sequence, resulting in a block \tilde{b}(0), . . . ,\tilde{b}(M_{bit}−1) of scrambled bits according to Equation 7.

\tilde{b}(i)=(b(i)+c(i))mod 2 [Equation 7]

In Equation 7, c(i) denotes the pseudo-random sequence and the pseudo-random sequence generator is initialized at the beginning of each subframe by cᵢₙᵢₜ=└n̅ₛ/2┘+1)·(2N_{ID}^{cell}+1)·2¹⁶+n_{RNTI}. Here, n̅ₛ=nₛ mod 20 and n_{RNTI} denotes a Cell Radio Network Temporary Identifier (C-RNTI).

The scrambled blocks \tilde{b}(0), . . . ,\tilde{b}(M_{bit}−1) of bits are Quadrature Phase-Shift Keying (QPSK) modulated, resulting in blocks d(0), . . . , d(M_{symb}−1) of the complex-valued modulation symbols. Here, M_{symb} is M_{bit}/2.

1) Layer Mapping

complex-valued modulation symbols to be transmitted are mapped to one or two layers. The complex-valued modulation symbols d(0), . . . , d(M_{symb}−1) are mapped to the x(i)=[x⁽⁰⁾(i) . . . x^{(v-1)}(i)]^{T}. Here, i=0, 1, . . . , M_{symb}^{layer}−1, v denotes the number of layers, and M_{symb}^{layer} denotes the number of modulation symbols per layer.

For transmission at a single antenna port, a single layer is used (i.e., v=1) and the mapping is defined according to Equation 8. In this case, M_{symb}^{layer} is M_{symb}⁽⁰⁾.

x⁽⁰⁾(i)=d(i) [Equation 8]

For transmission at two antenna ports, a mapping rule of two layers may be defined according to Equation 9. In this case, M_{symb}^{layer} is M_{symb}⁽⁰⁾/2.

x⁽⁰⁾(i)=d(2i)

x⁽¹⁾(i)=d(2i+1) [Equation 9]

2) Precoding

A precoder takes a block [x⁽⁰⁾(i) . . . x^{(v-1)} (i)]^{T} (here, i=0, 1, . . . , M_{symb}^{layer}−1) of vectors as an input from the layer mapping and generates a block [y⁽⁰⁾(i) . . . y^{(P-1)}(i)]^{T} (here, i=0, 1, . . . , M_{symb}^{ap}−1) of vectors to be mapped to the resource elements.

For the transmission at the single antenna port, precoding is defined by Equation 10. In this case, i=0, 1, . . . , M_{symb}^{ap}−1 and M_{symb}^{ap} is M_{symb}^{layer}.

y⁽⁰⁾(i)=x⁽⁰⁾(i) [Equation 10]

For the transmission at two antenna ports \tilde{p}∈{0,1}, an output y(i)=[y⁽⁰⁾(i) y⁽¹⁾(i)]^{T} of a precoding operation (here, i=0=0, 1, . . . , M_{symb}^{ap}−1) is defined by Equation 11. In this case, i=0, 1, . . . , M_{symb}^{layer}−1 and M_{symb}^{ap} is 2M_{symb}^{layer}.

$$[ \begin{matrix}{y}^{( 0 )} ( 2 i ) \\ {y}^{( 1 )} ( 2 i ) \\ {y}^{( 0 )} ( 2 i + 1 ) \\ {y}^{( 1 )} ( 2 i + 1 )\end{matrix} ] = \frac{1}{\sqrt{2}} [ \begin{matrix}1 & 0 & j & 0 \\ 0 & - 1 & 0 & j \\ 0 & 1 & 0 & j \\ 1 & 0 & - j & 0\end{matrix} ] [ \begin{matrix}Re ( {x}^{( 0 )} ( i ) \\ Re ( {x}^{( 1 )} ( i ) \\ Im ( {x}^{( 0 )} ( i ) \\ Im ( {x}^{( 1 )} ( i )\end{matrix} ] \qquad [ Equation 11 ]$$

The mapping to the resource elements is defined by the operation in quadruplets of the complex-valued symbols. When w^{(\tilde{p})}(i)= [symbol] y^{(\tilde{p})}(4i), y^{(\tilde{p})}(4i+1), y^{(\tilde{p})}(4i+2), y^{(\tilde{p})}(4i+3) [symbol] means a symbol quadruplet i for an antenna port \tilde{p}, a block w^{(\tilde{p})}(0), . . . , w(\tilde{p})(M_{quad}−1) (where, M_{quad}=M_{symb}/4) of the quadruplets is cyclically shifted, resulting in w^{(\tilde{p})}(0), . . . , w(\tilde{p})(M_{quad}−1) (where M_{quad}=M_{symb}/4). Here, w̅^{(\tilde{p})}(i)=w^{(\tilde{p})}((i+n_{cs}^{cell}(nₛ))mod M_{quad}).

For xPUCCH format 2, the block of the complex-valued symbols is mapped to z according to Equation 12.

z^{(\tilde{p})}(n_{xPUCCH}⁽²⁾·N_{xPUCCH}^{RB}·N_{sc}^{RB}+m′·N_{sc}^{RB}+k′)=w̅^{(\tilde{p})}(8m′+k) [Equation 12]

In Equation 12, k′ and m′ are as the following Equation 13.

$$\begin{matrix}{k}^{′} = \{ \begin{matrix}k & 0 \leq k \leq 1 \\ k + 2 & 2 \leq k \leq 5 \\ k + 4 & 6 \leq k \leq 7\end{matrix} \\ {m}^{′} = 0 , 1 , 2 , … , 5\end{matrix} \qquad [ Equation 13 ]$$

Further, n_{xPUCCH}⁽²⁾ is configured by the higher layers and indicated in the xPDCCH.

Sounding Reference Signal (SRS)

A sounding reference signal (SRS) is transmitted on port(s).

In regard to sequence generation, a SRS sequence is defined by r_{SRS}^{(\tilde{p})}(n)=r_{u,v}^{(α}^{_{\tilde{p}}}⁾(n), where u is a sequence group number, and v is a base sequence number. A cyclic shift α_{\tilde{p}} of the SRS may be given by Equation 14.

$$\begin{matrix}{α}_{\tilde{p}} = 2 π \frac{{n}_{SRS}^{cs , \tilde{p}}}{8} \\ {n}_{SRS}^{cs \tilde{p}} = [ {n}_{SRS}^{cs} + \frac{8 \tilde{p}}{{N}_{ap}} ] mod 8 \\ \tilde{p} ∈ \{ 0 , 1 , … , {N}_{ap} - 1 \}\end{matrix} \qquad [ Equation 14 ]$$

In Equation 14, n_{SRS}^{cs}∈{0,1,2,3,4,5,6,7} is configured for aperiodic sounding by higher layer parameter cyclicshift-ap for each UE, and Nₐₚ represents the number of antenna ports used in SRS transmission.

In regard to mapping to a physical resource, the sequence is multiplied by an amplitude scaling factor β_{SRS} in order to satisfy specified transmit power P_{SRS} in terms of SRS power control. Further, the sequence is mapped in sequence starting with r_{SRS}^{(\tilde{p})}(0) to resource elements (k, l) of an antenna port p according to Equation 15.

$${a}_{2 {k}^{′} + {k}_{0} , l}^{( p )} = \{ \begin{matrix}\frac{1}{\sqrt{{N}_{ap}}} {β}_{SRS} {r}_{SRS}^{( \tilde{p} )} ( {k}^{′} ) & {k}^{′} = 0 , 1 , … , {M}_{sc , b}^{RS} - 1 \\ 0 & otherwise\end{matrix} \qquad [ Equation 15 ]$$

In Equation 15, Nₐₚ represents the number of antenna ports used in SRS transmission, k₀ represents a starting point in a frequency domain of the SRS, and b=B_{SRS} and M_{sc,b}^{RS} represent a length of the SRS sequence defined by Equation 16.

M_{sc,b}^{RS}=m_{SRS,b}N_{sc}^{RB}/2 [Equation 16]

In Equation 16, m_{SRS,b} is given by Table 6, and a UE-specific parameter srs-Bandwidth, B_{SRS}∈{0,1,2,3} is given by higher layers. Table 6 indicates values of m_{SRS,b} for an uplink bandwidth of N_{RB}^{UL}=100.

TABLE 6

| | SRS- | SRS- | SRS- | SRS- |
|---|---|---|---|---|
| SRS bandwidth | Bandwidth | Bandwidth | Bandwidth | Bandwidth |
| configuration | B_{SRS} = 0 | B_{SRS} = 1 | B_{SRS} = 2 | B_{SRS} = 3 |
| C_{SRS} | m_{SRS, 0} | m_{SRS, 1} | m_{SRS, 2} | m_{SRS, 3} |
| 0 | 100 | 48 | 24 | 4 |

Further, k₀ representing the starting point in the frequency domain of the SRS is defined by Equation 17.

k₀=k̅_{TC}+n_{b}·N_{sc}^{RB} [Equation 17]

In Equation 17, k̅_{TC}∈{0,1} is given by a UE-specific parameter transmission Comb-ap provided for the UE by the higher layer, and n_{b} represents a frequency position index. n_{b} is maintained (when there is no reconfiguration) and is defined by n_{b}=4n_{RRC}. Here, the parameter n_{RRC} is given by a higher layer parameter freqDomainPosition-ap.

The SRS may be simultaneously transmitted on multiple component carriers (CCs).

In regard to SRS subframe configuration, the SRS is transmitted on a last symbol or a second last symbol according to a parameter conveyed in downlink control information (DCI). The UE may distinguish symbols for the SRS transmission via ‘SRS request (2 bits)’ in the DCI.

Physical Random Access Channel (xPRACH)

In regard to a random access preamble subframe, a random access preamble symbol of a physical layer may consist of a cyclic prefix of length T_{cp} and a sequence part of length T_{SEQ}.

FIG. 7 illustrates a method for receiving, by a base station, a random access channel (RACH) from a plurality of UEs. In FIG. 7, it is assumed that the UE transmits a preamble configured with preamble format 0 of Table 7. Table 7 indicates values of T_{GP1}, T_{CP}, T_{SEQ}, T_{SYM} and T_{GP2} according to the preamble format.

TABLE 7

| Preamble | | | | | |
|---|---|---|---|---|---|
| Format | T_{GP1} | T_{CP} | T_{SEQ} | N_{SYM} | T_{GP2} |
| 0 | 2224*Tₛ | 656*Tₛ | 2048*Tₛ | 10 | 456*Tₛ |
| 1 | 2224*Tₛ | 1344 *Tₛ | 2048*Tₛ | 8 | 1360*Tₛ |

The UEs occupy the same set of subcarriers, and each UE transmits two symbols (i.e., two preamble symbols). A first UE UE 1, a third UE UE 3, and a ninth UE UE 9 (i.e., odd-numbered UEs) are positioned around the base station and transmit a total of ten symbols. On the other hand, a second UE UE 2, a fourth UE UE 4, and a tenth UE UE 10 (i.e., even-numbered UEs) are positioned at a cell edge and transmit the same ten symbols. However, due to a difference in distance, signals of the even-numbered UEs arrive at the base station T_{RTT} time later than signals of the odd-numbered UEs.

Due to an extended cyclic prefix, there are ten symbols in a subframe for the preamble format 0, and there are eight symbols in a subframe for preamble format 1 for a distance of 1 km.

Configuration of different subframes for the RACH is given by Table 8.

TABLE 8

| PRACH | Preamble | System Frame | Subframe |
|---|---|---|---|
| configuration | Format | Number | Number |
| 0 | 0 | Any | 15, 40 |
| 1 | 0 | Any | 15 |

A RACH signal is transmitted on a single antenna port 1000. An antenna port (i.e., antenna port 1000) for the RACH signal needs to have the same directivity as the one during which the measurement of a selected beam reference signal (BRS) beam is conducted.

In regard to generation of a preamble sequence, a random access preamble is generated from a Zadoff-Chu sequence of length 71. In this instance, Zadoff-Chu sequence of a u-th root is defined by Equation 18.

$${x}_{u} ( n ) = {e}^{- j \frac{π un ( n + 1 )}{{N}_{ZC}}} , 0 \leq n \leq {N}_{ZC} - 1 \qquad [ Equation 18 ]$$

In Equation 18, length N_{ZC} of the Zadoff-Chu sequence is 71, and a value of the root u is provided by the higher layer. In this instance, the random access preamble is mapped to resource elements according to Equation 19.

$$\begin{matrix}{a}_{k , l} = f \cdot {x}_{u} ( n ) {e}^{- j \frac{2 π}{3} vk} , v ∈ \{ 0 , 1 , 2 \} \\ k = n + 1 + 12 ⋆ ( 6 ⋆ {n}_{RACH} + 1 ) , {n}_{RACH} ∈ \{ 0 , 1 … 7 \} \\ f = \{ \begin{matrix}1 & if 1 is even \\ {f}^{′} & if 1 is odd \end{matrix} \\ {f}^{′} ∈ \{ - 1 , 1 \} \\ n = 0 , 1 … , 70 , \\ 1 ∈ \{ \begin{matrix}\{ ( 0 , 1 ) , ( 2 , 3 ) , ( 4 , 5 ) , ( 6 , 7 ) , ( 8 , 9 ) \} & for format 0 \\ \{ ( 0 , 1 ) , ( 2 , 3 ) , ( 4 , 5 ) , ( 6 , 7 ) \} & for format 1\end{matrix} \}\end{matrix} \qquad [ Equation 19 ]$$

In Equation 19, a cyclic shift v, a RACH subband index n_{RACB}, and a parameter f are provided by the higher layers. For the preamble format 0, the cyclic shift v has three values. On the other hand, when the preamble format 1 is configured, one of cyclic shift values is used in a cell. A RACH subframe provides 8 RACH subbands, and each RACH subband occupies 6 RBs. Here, a parameter n_{RACB} determines which subband is used by the UE.

During a synchronization subframe, the UE identifies a symbol with a strong beam. A set of parameters provided by an upper layer is used to map a symbol with a selected beam to RACH symbol index 1. Further, higher layers determine a component carrier (CC) in which the UE transmits a RACH signal.

In regard to a procedure calculating a symbol of the RACH signal, layer 1 receives the following parameters from the higher layer.
System frame number (SFN)
BRS transmission period (symbol unit, N_{BRS}=BRS transmission period in a slot x 7)
The number N_{RACH} of symbols during a RACH subframe in which the base station applies different reception beams (N_{RACH}=5 if the preamble format is 0, and N_{RACH}=4 if the preamble format is 1)
The number M of RACH subframes in each radio frame (M∈{1,2}, change depending on RACH configuration)
Index m (m∈{0, . . . , M−1}) of RACH subframe
Synchronous symbol index S_{sync}^{beam}(S_{sync}^{beam}∈{0, . . . , N_{BRS}−1}) of selected beam

Further, the RACH subframe uses the same beam as a synchronization subframe and in the same sequential order. Thus, if a m-th RACH subframe occurs within a radio frame with the system frame number (SFN), it will use beams of synchronous symbols identified by a set of Equation 20.

(M·SFN·N_{RACH}+m·N_{RACH}+(0:N_{RACH}−1))%N_{BRS},m∈{0, . . . ,M−1} [Equation 20]

If S_{sync}^{beam} is one of these symbols, the UE shall transmit a RACH preamble during the RACH subframe. The transmission should start at a symbol that follows the following Equation 21.

l=((S_{sync}^{beam}−(SFN·M·N_{RACH}m·N_{RACH}+m·N_{RACH})%N_{BRS})%N_{BRS})·Nᵣₑₚ, [Equation 21]

In Equation 21, Nᵣₑₚ represents the number of symbols dedicated to a single RACH transmission. Here, Nᵣₑₚ may be 2.

In regard to generation of a baseband signal, the baseband signal for a PRACH may be generated with a tone spacing of Δf=75 kHz. In this case, a cyclic prefix with length N_{CP} of 656 or 1344 sample is inserted corresponding to a preamble format provided by higher layer.

In regard to collection of a scheduling request (SR) during a RACH period, symbols for the SR may be transmitted during the RACH subframe. The symbols occupy a different set of subcarriers from a set of subcarriers occupied by a RACH signal. The SR is collected from any UE in a similar manner as the RACH signal. In this case, the preamble for the SR (i.e., SR preamble) may consist of a cyclic prefix of length T_{CP} and a sequence part of length T_{SEQ}. Both have the same value as their counterparts of the RACH preamble. Table 9 indicates values of T_{CP} and T_{SEQ} according to preamble configuration for the SR.

TABLE 9

| Preamble | | |
|---|---|---|
| configuration | T_{CP} | T_{SEQ} |
| 0 | 656 Tₛ | 2048 Tₛ |
| 1 | 1344 Tₛ | 2048 Tₛ |

In regard to generation of a preamble sequence for the SR transmitted during the RACH period, the SR preambles are generated from Zadoff-Chu sequences. Higher layers control a set of preamble sequences used by the UE. In this instance, a length of a SR preamble sequence is 71. Zadoff-Chu sequence of a u-th root is defined by Equation 22.

$${x}_{u} ( n ) = {e}^{- j \frac{π un ( n + 1 )}{{N}_{ZC}}} , 0 \leq n \leq {N}_{ZC} - 1 \qquad [ Equation 22 ]$$

In Equation 22, N_{ZC} is 71, and twelve different cyclic shifts of the corresponding sequence are defined to obtain the SR preamble sequence. The random access preamble xᵤ(n) is mapped to resource elements according to Equation 23.

$$\begin{matrix}\begin{matrix}{a}_{k , l} = f \cdot {x}_{u} ( n ) {e}^{- j \frac{2 π}{12} vk} , v ∈ \{ 0 , 1 , 2 , … 11 \} \\ k = n + 1 + 12 ⋆ ( 6 ⋆ {N}_{SR} + 51 ) , \\ n = 0 , 1 , … , 70 \\ f = \{ \begin{matrix}1 & if 1 is even \\ {f}^{′} & if 1 is odd \end{matrix} \\ {f}^{′} ∈ \{ - 1 , 1 \} . \\ 1 ∈ \{ \begin{matrix}\{ ( 0 , 1 ) , ( 2 , 3 ) , ( 4 , 5 ) , ( 6 , 7 ) , ( 8 , 9 ) \} & for format 0 \\ \{ ( 0 , 1 ) , ( 2 , 3 ) , ( 4 , 5 ) , ( 6 , 7 ) \} & for format 1\end{matrix} \}\end{matrix} & \end{matrix} \qquad [ Equation 23 ]$$

In Equation 23, the RACH subframe provides multiple subbands for the SR transmission, and each subband occupies 6 RBs. Here, N_{SR} determines which subband is used by the UE. Further, the values of u, v, f′, and N_{SR} are received from the upper layers. The symbol index 1 is calculated in the same manner as a procedure calculating the symbol of the RACH signal described above.

A baseband signal for the SR is generated in the same manner as a manner for generating the baseband signal for the RACH described above.

The NR system may use not only digital beamforming (i.e., beamforming based on a precoding matrix) but also analog beamfoming, unlike existing legacy LTE. That is, in the NR system, there may be considered a hybrid beamforming scheme that is a combined type of the digital beamforming and the analog beamfoming.

The analog beamfoming scheme configures a beam of the base station and/or the UE in a physical manner, unlike the digital beamforming scheme. For example, the base station and/or the UE may configure transmission and reception beams using a phase shift (PS) and/or a power amplifier (PA).

In this case, there may occur a case where the UE should request scheduling (i.e., beam scheduling) for the beam to the base station (e.g., gNB) for the purpose of beam configuration with the base station. For example, when it is determined that an optimal beam of the UE and the base station has changed, the UE may request a beam change, or when it is determined that the beam is twisted, the UE may request beam refinement.

As described above, in the NR system, there is a need to newly define a procedure and a scheme of a scheduling request related to a beam performed by the UE. That is, there is a need to additionally consider a method in which the UE transmits not only a scheduling request (SR) for existing data (i.e., for requesting resource allocation for data transmission) but also a scheduling request related to a beam. Hereinafter, for convenience of explanation, the scheduling request for data is called a data SR, and the scheduling request related to the beam is called a beam related SR.

Accordingly, the present specification proposes a method for transmitting, by the UE, various types (or kinds, states) of scheduling requests in the NR system considering the self-contained subframe (or slot) structure described above. More specifically, the present specification describes a method for transmitting periodically (i.e., periodic SR transmission method) and aperiodically (i.e., aperiodic SR transmission method), by the UE, various types of scheduling requests.

In the NR system, a method proposed by the present specification may be classified into a periodic SR transmission method (first embodiment) and an aperiodic SR transmission method (second embodiment) depending on the SR transmission method and may apply both the first embodiment and the second embodiment, if necessary.

### First Embodiment—Periodic SR Transmission Method

A first embodiment relates to a method for periodically transmitting, by a UE, a scheduling request (SR) (e.g., data SR, beam related SR, etc.). In the NR system, the UE may be configured to transmit an uplink control region (e.g., uplink control channel) in each subframe (or slot) via a subframe (or slot) of a self-contained structure. However, even when a subframe, in which there is no uplink control region according to frame configuration of a system, is configured in a frame, it is obvious that the following methods described in the present specification can be applied.

In this case, a base station may periodically configure, for the UE, an occasion (i.e., SR transmission occasion) where the UE can transmit a SR, by reserving some resources of an uplink control channel region at intervals of a specific period. Hence, the UE can transmit the SR to the base station at a specific time point (i.e., a time point at which it is determined that the SR transmission is needed) among the periodically configured (i.e. coming) SR transmission occasion.

In this instance, as described above, the data SR and the beam related SR, etc. may be considered as the SR transmitted by the UE. Here, the beam related SR may include a SR requesting a change of a beam (i.e., beam change request), a SR requesting a beam refinement reference signal (BRRS) (i.e., BRRS initiation request), etc.

In the first embodiment, as a method for periodically transmitting, by the UE, the SR, there may be roughly considered a method (Method 1) for transmitting a SR using an uplink control channel (e.g., PUCCH) resource that is periodically allocated in an uplink control region, and a method (Method 2) for transmitting a SR in a subframe transmitting a random access channel (e.g., PRACH).

(Method 1: Method for Transmitting SR Using Uplink Control Channel Resource)

A method for transmitting, by a UE, a SR using (or utilizing) an uplink control channel (e.g., PUCCH) resource that is periodically allocated in an uplink control region is first described below.

The UE may transmit a plurality of SRs in the same manner as a method for transmitting 2-bit HARQ-ACK in the uplink control channel, regardless of a transmission structure of the uplink control channel (e.g., PUCCH). For example, the UE may allocate a SR type to each symbol and transmit the SR, as in the case of transmitting 2-bit HARQ-ACK utilizing a quadrature phase shift keying (QPSK) modulation symbol. More specifically, a data SR may be allocated to ‘00’, a SR for beam change request among a beam related SR may be allocated to ‘01’, and a SR for BRRS initiation request among the beam related SR may be allocated to ‘10’.

For another example, the UE may maps the above-described SRs (i.e., SR types) to cyclic shifts (CSs) of a sequence and transmit it, in the same manner as a method for transmitting 2-bit HARQ-ACK by mapping it to a cyclic shift (CS) (or CS index) of a sequence. In this case, the base station may allocate CS indexes corresponding to the number of SR types (or kinds) to each UE. A mapping relation between the SRs and the CSs of the sequence may be previously defined on the system, or the base station may deliver configuration information for the corresponding mapping relation to the UE via higher layer signaling and/or downlink control information.

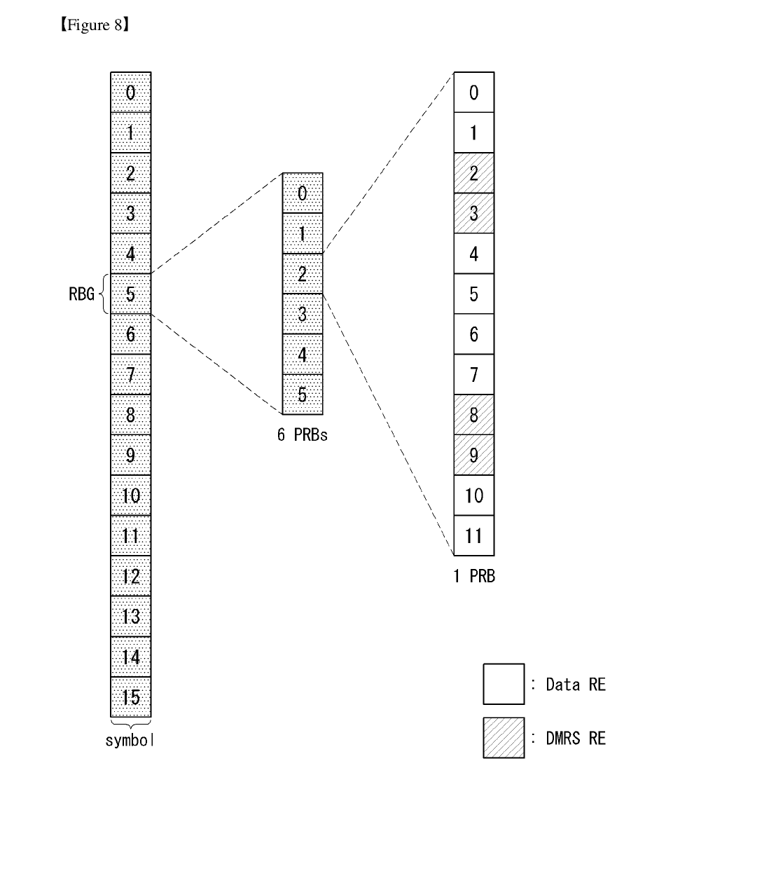

In the case of transmitting the SR through the same structure as the uplink control channel, the UE may configure the SR in the same manner as the uplink control channel in a unit of six physical resource blocks (PRBs) and transmit the SR, as shown in FIG. 8.

FIG. 8 illustrates an example of an uplink control channel structure applicable to a NR system. FIG. 8 is merely for convenience of explanation and does not limit the scope of the present invention.

Referring to FIG. 8, it is assumed that the UE transmits an uplink control channel configured in a unit of one symbol (i.e., one OFDM symbol).

As illustrated in FIG. 8, the uplink control channel of one unit may be configured according to a resource block group (RBG) and a unit of a physical resource block (PRB). In this instance, the resource block group may consist of 6 physical resource blocks, and each physical resource block may consist of twelve resource elements (REs). In other words, the resource block group for uplink control channel transmission may consist of a total of 72 resource elements.

In this instance, the number of physical resource blocks constituting the resource block group may be differently configured. For example, when the resource block group consists of 5 physical resource blocks, the corresponding resource block group may consist of 60 resource elements. For another example, when the resource block group consists of 4 physical resource blocks, the corresponding resource block group may consist of 48 resource elements. Further, in addition to the number of physical resource blocks constituting the resource block group, the number of resource elements constituting the physical resource block may be differently configured.

In this case, as described above, the UE may map to QPSK modulated symbol data corresponding to a specific SR to REs and transmit the SR to the base station. Alternatively, the UE may transmit the SR in a different structure from the uplink control channel, i.e., in a unit of one physical resource block.

However, as described above, when the base station periodically allocates resources for the SR transmission, a restriction on an operation of the base station may occur. For example, even when the base station intends to configure each subframe (or slot) of a specific frame to be dedicated to only downlink, the base station needs to allocate a specific symbol for a periodic uplink resource (e.g., periodic SR transmission resource) for the uplink purpose. Alternatively, for another example, considering analog beamforming, even when a very small number of UE(s) exist in a specific beam direction, the base station needs to allocate a specific uplink resource and a specific beam resource for the corresponding UE(s).

Accordingly, even if resources are periodically allocated, the base station may indicate to the UE so that the UE does not use a specific resource in the SR transmission. For example, the base station may reserve a SR transmission resource via the uplink control channel every 5 ms and notify (or indicate) a prohibit timing to the UE, in order for the UE not to use the specific SR resource.

The prohibit timing may be a timer or indication information indicating that the specific resource is not used in the SR transmission. The base station may notify (or transmit) configuration information about the prohibit timing to the UE via downlink control information (DCI) and/or higher layer signaling. In this instance, the prohibit timing may be configured to be cell-specific or UE-specific. Here, the fact that it is configured to be cell-specific may mean that the prohibit timing may be commonly configured in a cell. That is, the prohibit timing configured in cell-specific may mean a prohibit timing configured in cell-common.

When resources for SR transmission are periodically configured, a method for configuring to transmit the SR only if the UE transmits HARQ-ACK in the corresponding resources may be also considered.

(Method 2: Method for Transmitting SR in a Subframe for Transmission of Random Access Channel)

Unlike the method 1, there may be considered a method for transmitting, by a UE, a SR using a PRACH and a frequency division multiplexing (FDM) structure in a subframe (or a slot) in which a random access channel (e.g., PRACH) is transmitted. For example, the UE may transmit a SR in a subframe (i.e., PRACH subframe) for PRACH transmission illustrated in FIG. 7. In this case, in order to transmit the SR using the PRACH and a FDM scheme, the UE may configure and transmit a SR preamble (i.e., a preamble for transmitting the SR) in the same manner as a PRACH preamble.

Referring to FIG. 7, the PRACH preamble may be configured to successively transmit two preambles in one beam direction (or one UE). On the other hand, the SR preamble may be configured so that the two preambles for one beam direction are transmitted by different UEs. Hence, multiplexing capacity between the UEs can be improved through a TDM scheme for the SR transmission (i.e., SR preamble transmission).

Further, a unit of a resource block (RB) at a frequency axis for the SR transmission may be configured in the same manner as the PRACH transmission. A unit at the frequency axis for the SR transmission is configured on a per one physical resource block (i.e., 1 PRB) basis, and the SR transmissions may be performed through the FDM scheme. Hence, multiplexing capacity between the UEs can be improved through the FDM scheme for the SR transmission. Because a transmission spacing in the PRACH transmission is relatively long, multiple UEs may concentrate at a specific PRACH transmission time point (i.e., a specific PRACH subframe). In regard to this, the improvement of the above-described multiplexing capacity may be usefully applied to the case where the multiple UEs should transmit the SR in the specific PRACH subframe.

As a method for transmitting, by the UE, a SR (i.e., SR preamble), there may be considered a method for distinguishing SR types (or kinds) through an applied CS index by using a Zadoff-Chu sequence as in a PRACH. For example, when the SR preamble is generated from the Zadoff-Chu sequence, CS index 0 applied to a SR preamble sequence may indicate a data SR, CS index 4 may indicate a SR requesting a beam change among beam related SRs, and CS index 8 may indicate a SR requesting an initiation of a BRRS among the beam related SRs. Alternatively, CS indexes applied to the SR preamble may be configured to be grouped according to the SR type. In this case, a first CS index group (e.g., CS indexes 0 to 3) may indicate the data SR, and a second CS index group (e.g., CS indexes 4 to 11) may indicate the beam related SR. The second CS index group for the beam related SR may be sub-grouped into CS index subgroups. That is, a first CS index subgroup (e.g., CS indexes 4 to 7) may be configured to indicate the SR requesting the beam change, and a second CS index subgroup (e.g., CS indexes 8 to 11) may be configured to indicate the SR requesting the beam refinement (i.e., SR requesting the initiation of the BRRS).

In addition, as a method for transmitting, by the UE, a SR, the may be considered a method for transmitting a SR by mapping a QPSK modulated symbol corresponding to a specific SR type to each RE. For example, ‘00’ may be allocated to the data SR, ‘01’ may be allocated to the SR requesting the beam change, and ‘10’ may be allocated to the SR requesting the initiation of the BRRS.

When the UE transmits a PRACH preamble and a SR preamble in a PRACH subframe, the PRACH preamble and the SR preamble may be configured with the same kind of sequences. In this case, the PRACH preamble and the SR preamble may be multiplexed in a code domain through a code division multiplexing (CDM) scheme.

When the UE transmits the PRACH preamble and the SR preamble in the PRACH subframe as described above, information on a location of resources transmitting the SR (i.e., SR preamble) may be indicated to the UE by the base station via downlink control information (DCI) and/or higher layer signaling or the like.

Unlike this, a method for implicitly transmitting, by the UE, a SR using a PRACH preamble may be considered. That is, in a subframe (i.e., PRACH subframe) for PRACH transmission illustrated in FIG. 7, the UE may transmit only the PRACH preamble and perform a random access procedure and a SR procedure at the same time. In this case, the SR may be implicitly indicated using CS indexes applied to a sequence of the PRACH preamble. For example, specific CS indexes among the CS indexes applicable to the sequence of the PRACH preamble may be used to indicate the SR transmission.

More specifically, the specific CS indexes may be grouped such that a first CS index group (e.g., CS indexes 0 to 19) may be configured to be used for only a random access without the data SR and/or the beam related SR, a second CS index group (e.g., CS indexes 20 to 39) may be configured to indicate the data SR at the same time as the random access, and a third CS index group (e.g., CS indexes 40 to 59) may be configured to indicate the beam related SR at the same time as the random access. Further, the third CS index group for the beam related SR may be sub-grouped into CS index subgroups such that a first CS index subgroup (e.g., CS indexes 40 to 49) may be configured to indicate the SR requesting the beam change, and a second CS index subgroup (e.g., CS indexes 50 to 59) may be configured to indicate the SR requesting the beam refinement (i.e., SR requesting the initiation of the BRRS). In this instance, the base station may deliver (or indicate) configuration information about the grouping of the CS indexes to the UE via higher layer signaling and/or downlink control information (DCI) or the like.

When a PRACH preamble sequence is configured with the Zadoff-Chu sequence, not only CS indexes applied to the PRACH preamble sequence but also root indexes for the Zadoff-Chu sequence may be used to indicate the SR. In this case, it is obvious that the root indexes can be grouped as in the above-described CS indexes to indicate various SR types.

In various embodiments of the present invention, a method (method 1) for transmitting a SR using the above-described uplink control channel resources and a method (method 2) for transmitting a SR in a subframe (i.e., PRACH subframe) for the PRACH transmission may be combined and applied. For example, the UE may be configured to transmit both a data SR and a beam related SR (e.g., SR requesting a beam change, SR requesting an initiation of a BRRS) in the PRACH subframe and transmit only the data SR in an uplink control channel region (e.g., PUCCH region). Alternatively, for another example, the UE may be configured to transmit the beam related SR using a modulation symbol (e.g., QPSK modulated symbol, BPSK modulated symbol) in the PRACH subframe and transmit the data SR in the uplink control channel region. In this case, the type (or kind) of the SR and a location (i.e., the PRACH subframe or the uplink control channel region) transmitting each SR type may be configured in various combinations in addition to the above examples.

In various embodiments of the present invention, a SR transmitted in the PRACH subframe (i.e. subframe for the random access channel transmission) and a SR transmitted in the uplink control channel region are not limited to a specific channel and may be replaced by a SR of a long period (i.e., long period SR) and a SR of a short period (i.e., short period SR). That is, the UE may transmit the long period SR in the PRACH subframe and transmit the short period SR in the uplink control channel region.

A value (i.e., prohibit timing) of a prohibit timer that prevents the SR from being transmitted during a predetermined duration may be set independently for each of the long period SR and the short period SR. For example, the value of the prohibit timer for the SR transmitted in the PRACH subframe may be set to ‘0’.

A value and/or a period of the prohibit timer related to the prohibit timing may be differently set according to the above-described various types of SRs. For example, the value and/or the period of the prohibit timer may be differently set according to the data SR and the beam related SR (i.e., SR requesting the beam change or SR requesting the initiation of the BRRS). For example, a value of the prohibit timer for the beam related SR may be set to be less than a value of a prohibit timer for general data SR and may be extremely set to ‘0’.

If a plurality of different types of SRs, in which the same transmission timing period and/or offset are configured, are transmitted simultaneously, each of the simultaneously transmitted SR types may be configured with a different prohibit timer. In this case, the UE may perform the following SR transmission according to a prohibit timer with a smallest value among the different prohibit timers.

An aperiodic SR to be described later may be configured to follow the configuration of the prohibit timer configured for the periodic SR. For example, the UE may attempt the SR transmission on a SR resource of a closest time point before and after a time point at which a value (or duration) of the prohibit timer has passed from an aperiodic SR transmission time point. In this instance, the SR resource may include a periodic SR resource or an aperiodic SR resource.

In various embodiments of the present invention, there may be considered a method for configuring a SR counter applying a restriction to the transmission number of SR. In this case, a system or the base station may set a maximum number of the SR counter and inform the UE of it. Each time the UEs transmit the SR, they may be configured to increase a value of the SR counter by one.

When the value of the SR counter increases up to the maximum number due to the successive SR transmission of the UE (i.e., when the value of the SR counter reaches the maximum number), the UE does not additionally transmit the SR and may perform an initial access operation or SR transmission utilizing the initial access operation. Further, the SR counter (or the SR counter value) may be configured to vary depending on the various SR types.

For example, the SR counter may be independently configured to vary according to the data SR and the beam related SR (i.e., SR requesting the beam change or SR requesting the initiation of the BRRS). For example, a maximum number of the SR counter for the beam related SR may be set to be less (or lower) than a maximum number of the SR counter for the data SR. Hence, the UE in the case of the beam related SR may be configured to perform earlier the initial access operation or the SR transmission utilizing the initial access operation.

The same type of SRs may be configured to apply (or share) one SR counter (i.e., a SR counter in which a maximum number is set to the same value) regardless of whether the same type of SRs are the long period SR or the short period SR.

### Second Embodiment—Aperiodic SR Transmission Method

The first embodiment described above relates to a method for periodically transmitting, by a UE, a SR, whereas a second embodiment to be described below relates to a method for aperiodically transmitting, by the UE, the SR. That is, the UE may be configured to transmit the SR aperiodically as well as periodically. Here, it is assumed that the SR exists in various types (or kinds, states) such as a data SR and a beam related SR, as described above.

In the second embodiment, as a method for aperiodically transmitting, by the UE, the SR, there may be roughly considered a method (Method 1) for transmitting a SR together when the UE performs transmission of an uplink control channel (e.g., PUCCH), and a method (Method 2) for transmitting a SR using a sounding reference signal (SRS).

(Method 1: Method for Transmitting SR Together with Transmission of Uplink Control Channel)

A method for transmitting, by a UE, a SR together with transmission of an uplink control channel is first described below. In this case, there may be considered a method for implicitly transmitting, by the UE, a SR using a reference signal (RS) transmitted on the uplink control channel (e.g., PUCCH).

For example, when a pseudo-random sequence is transmitted to a reference signal in an uplink control channel (e.g., PUCCH) structure illustrated in FIG. 8, the SR may be implicitly transmitted using a seed value of the pseudo-random sequence. In this case, one or multiple seed value(s) of the pseudo-random sequence may be assigned according to the number of SR types, and the UE may be configured to transmit the uplink control channel while differently setting the seed value of the pseudo-random sequence of the reference signal according to the SR type. For example, different seed values may be respectively configured for a data SR and a beam related SR (specifically, it may be distinguished into a SR requesting a beam change and a SR requesting an initiation of a BRRS).

In this instance, the multiple seed values may be generated using a cell-radio network temporary identifier (C-RNTI) value of the UE, or may be delivered to the UE by a base station via higher layer signaling and/or downlink control information (DCI) or the like.

Alternatively, unlike this, when the UE transmits the uplink control channel using a constant amplitude zero autocorrelation waveform (CAZAC) sequence such as a Zadoff-Chu sequence, the UE may transmit the SR using CS index(es) applicable to the Zadoff-Chu sequence.

In this case, the CS indexes may be differently configured according to the SR type and may be grouped to indicate the SR type. For example, a first CS index group (e.g., CS indexes 20 to 39) may be configured to indicate the data SR, and a second CS index group (e.g., CS indexes 40 to 59) may be configured to indicate the beam related SR. The second CS index group for the beam related SR may be sub-grouped into CS index subgroups such that a first CS index subgroup may be configured to indicate a SR requesting the beam change, and a second CS index subgroup may be configured to indicate a SR requesting the beam refinement (i.e., SR requesting the initiation of the BRRS).

In this instance, the base station may allocate CS index(es), applicable to the Zadoff-Chu sequence, corresponding to the number of SR types to the UE, and hence, the UE may transmit different types of SRs using the allocated CS index(es).

(Method 2: Method for Transmitting SR Using Sounding Reference Signal)

Unlike the method 1, a method for transmitting, by a UE, a SR using a sounding reference signal (SRS) may be considered. That is, the UE may transmit a specific type of SR simultaneously while transmitting the SRS for a channel state estimation. There may be considered a method for transmitting, by the UE, multiple types (or kinds, states) of SRs (e.g., data SR, beam related SR, etc.) using multiple (i.e., a plurality of) SRS resources occupying the same frequency band. Hence, the multiple SRS resources may be divided according to a FDM scheme or a CDM scheme.

For example, when the SRS configured with a Zadoff-Chu sequence is transmitted, the multiple SRSs may be divided according to a cyclic shift (CS) (i.e., CS index), a comb index, and/or a root index or the like. For another example, when the SRS configured with a pseudo-random sequence is transmitted, the multiple SRSs may be divided according to an orthogonal cover code (OCC), a comb index, and/or a scrambling ID or the like.

More specifically, in one embodiment of the present invention, the UE may transmit different types (purposes) of SRs according to a CS index and/or a transmission location (i.e., comb index) of a comb structure (e.g., even comb structure, odd comb structure) of a sequence applied to the SRS. In this case, the base station may allocate CS index(es) and/or comb index(es) corresponding to the number of SR types to the UE. The CS indexes for the SRS transmission may be grouped to indicate the SR type. For example, a first CS index group (e.g., CS indexes 20 to 39) may be configured (i.e., represented) to indicate the data SR, and a second CS index group (e.g., CS indexes 40 to 59) may be configured to indicate the beam related SR. The second CS index group for the beam related SR may be sub-grouped into CS index subgroups such that a first CS index subgroup may be configured to indicate a SR requesting a beam change, and a second CS index subgroup may be configured to indicate a SR requesting beam refinement (i.e., SR requesting an initiation of a BRRS).

The base station may transmit configuration information related to the SR transmission described above to the UE via higher layer signaling and/or downlink control information (DCI) or the like. In this instance, there may be considered a method for mapping combinations of CS indexes and comb indexes to multiple SR types.

Afterwards, the UE may use (select) a CS index and/or a comb index corresponding a SR, which the UE intends to transmit, among the allocated CS index(es) and/or comb index(es) and may transmit the SR.

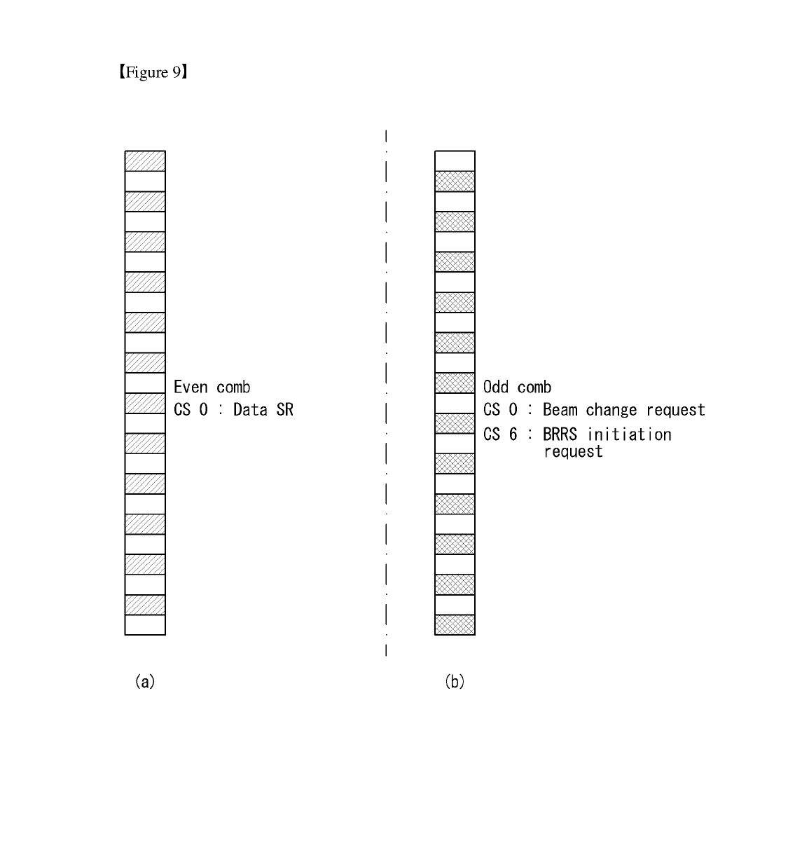

FIG. 9 illustrates an example of a method for transmitting a SR using a sounding reference signal (SRS) to which a method proposed by the present specification is applicable. FIG. 9 is merely for convenience of explanation and does not limit the scope of the present invention.

Referring to FIG. 9, it is assumed that the UE combines CS (i.e., CS index) and a comb structure (i.e., comb index, transmission location of comb structure) of a sequence used for the SRS transmission and transmits a SR. In this case, the transmission location of the comb structure may be divided into an even index comb structure (i.e., comb structure using even-numbered subcarrier indexes) and an odd index comb structure (i.e., comb structure using odd-numbered subcarrier indexes). Here, it is obvious that the comb structure can be configured with various structures in addition to the even index comb structure and the odd index comb structure.

More specifically, as shown in (a) of FIG. 9, a combination of the even index comb structure and CS index 0 may be allocated to transmission of a data SR. In this case, the UE may apply the CS index 0 to even indexes (i.e., even-numbered indexes of subcarrier indexes) and transmit a SRS, in order to transmit the data SR.

Further, as shown in (b) of FIG. 9, a combination of the odd index comb structure and CS index 0 or 6 may be allocated to transmission of a beam related SR. In this case, the UE may apply the CS index 0 to odd indexes (i.e., odd-numbered indexes of subcarrier indexes) and transmit a SRS, in order to request a beam change (i.e., in order to transmit a SR for requesting the beam change). The UE may apply the CS index 6 to the odd indexes and transmit a SRS, in order to request an initiation of a beam refinement reference signal (BRRS) (i.e., in order to transmit a SR for requesting the initiation of the BRRS).

In other embodiments of the present invention, when the UE does not transmit the SRS at a full bandwidth at a time and dividedly transmits the SRS in a plurality of subbands, the UE may transmit different types of SRs according to a hopping pattern of the plurality of subbands. For example, there may be considered a method for dividing multiple SRS transmissions on a per subband basis and transmitting a different type of SR according to transmission order of a corresponding subband.

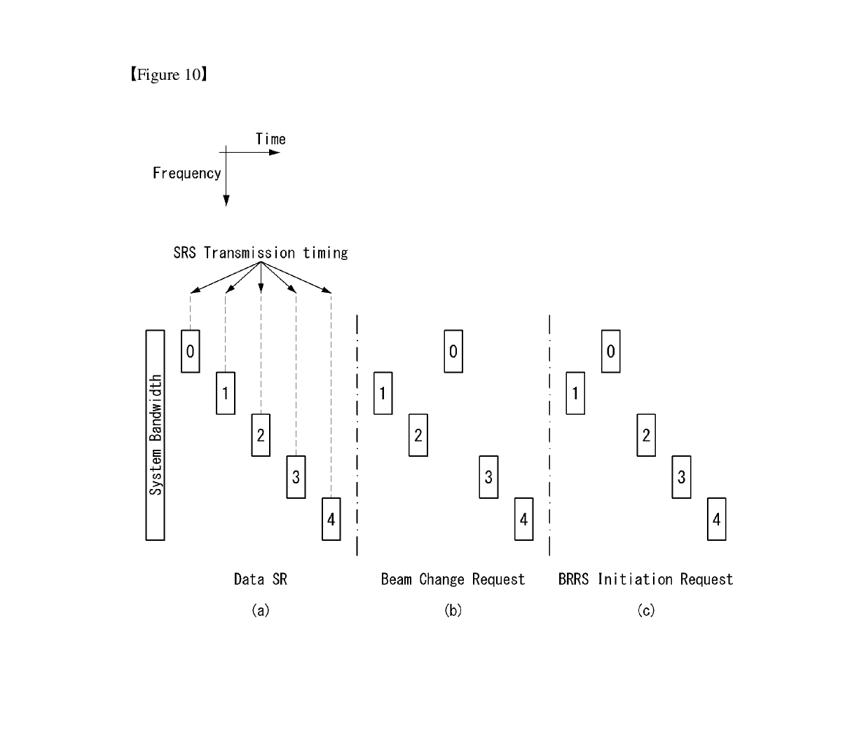

FIG. 10 illustrates another example of a method for transmitting a SR using a SRS to which a method proposed by the present specification is applicable. FIG. 10 is merely for convenience of explanation and does not limit the scope of the present invention.

Referring to FIG. 10, it is assumed that the UE transmits not a SRS for a full system bandwidth allocated for the SRS transmission but a SRS configured per subband. The system bandwidth may be divided into five SRS transmission subbands. That is, a frequency bandwidth at which each SRS is transmitted may be configured differently. Here, the five SRS transmission subbands may be called subband 0, subband 1, subband 2, subband 3, and subband 4.

Each of the five subbands may be transmitted at a different SRS transmission timing, and a hopping pattern may be determined according to transmission order of the subbands. For example, transmitting the SRS in order of subband 0, subband 5, subband 4, subband 2, and subband 3 may be called hopping pattern 0-5-4-2-3. The UE may be configured to transmit a specific type of SR using the hopping pattern.

For example, hopping pattern 0-1-2-3-4 of the SRS transmission illustrated in (a) of FIG. 10 may be allocated to the transmission of data SR, hopping pattern 1-2-0-3-4 of the SR transmission illustrated in (b) of FIG. 10 may be allocated to the transmission of a beam change request (i.e., SR requesting a beam change), and hopping pattern 1-0-2-3-4 of the SR transmission illustrated in (c) of FIG. 10 may be allocated to the transmission of a beam refinement reference signal (BRRS) initiation request (i.e., SR requesting an initiation of an BRRS). Further, pattern(s) other than the hopping patterns may be allocated to the case of transmitting only the SRS without information representing the SR.

In this case, the UE may transmit the data SR by transmitting the SRS via subbands to which the hopping pattern 0-1-2-3-4 is applied, transmit the beam change request by transmitting the SRS via subbands to which the hopping pattern 1-2-0-3-4 is applied, and transmit the BRRS initiation request by transmitting the SRS via subbands to which the hopping pattern 1-0-2-3-4 is applied. Further, the base station may configure a pattern of an appropriate combination for each UE so that the multiple UEs are multiplexed with each other.

Considering the number of SR types, there may be considered a method for indicating (or designating) a SR type using only a part combination (e.g., a front part of the hopping pattern) of the SRS hopping pattern. For example, as described in the above examples, when the hopping for the SR transmission is indicated 5 times in total, the front two patterns in the hopping pattern may be configured to indicate a specific SR type. More specifically, the front two patterns ‘0-1’ in the hopping pattern that is indicated 5 times in total may be configured to indicate the data SR, the front two patterns ‘1-2’ may be configured to indicate the beam change request, and the front two patterns ‘1-0’ may be configured to indicate the BRRS initiation request. The base station may deliver (or indicate) information on the configuration to the UE via higher layer signaling and/or downlink control information (DCI) or the like. Since the method transmits (or indicates) the SR using only the front part pattern of the hopping pattern, there is an advantage that time required in the SR transmission can be reduced.

In the case of the method of using the hopping pattern of the subbands related to the SRS transmission, the UE may implicitly transmit different types of SRs by changing only the hopping pattern in a fixed (or predetermined) CS index and/or a fixed comb structure. Alternatively, the UE may implicitly transmit (or indicate) different types of SRs through the SRS transmission configured by combining a method of using the above-described CS index and/or the comb structure and a method of using the hopping pattern.

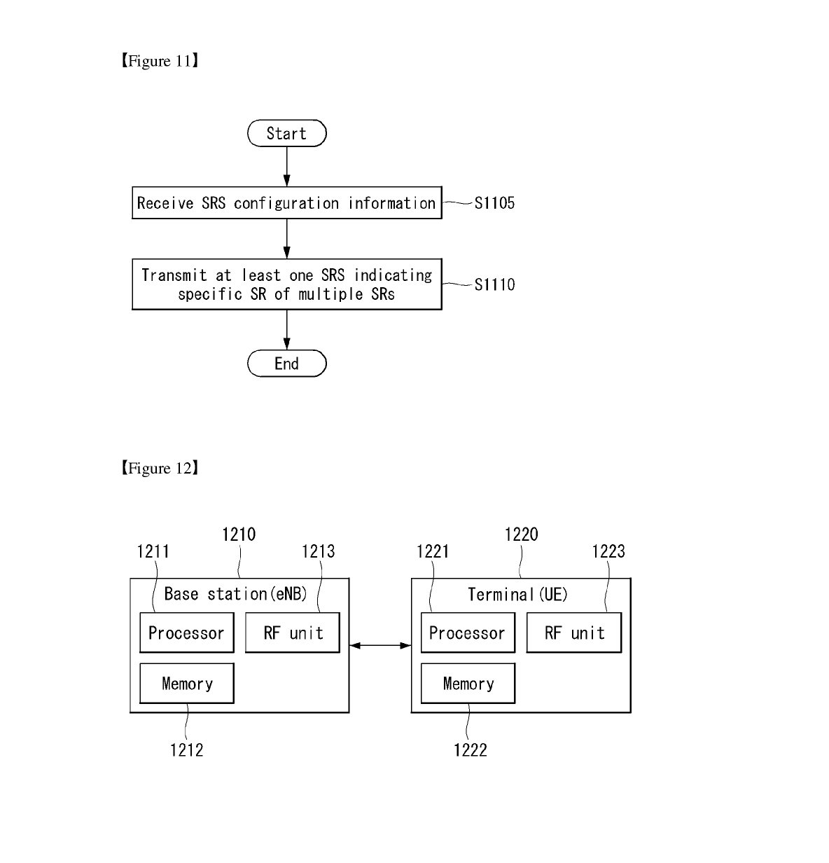

FIG. 11 illustrates an operation flow chart of a UE for transmitting a scheduling request (SR) to which a method proposed by the present specification is applicable. FIG. 11 is merely for convenience of explanation and does not limit the scope of the present invention.

Referring to FIG. 11, it is assumed that a UE transmits a beam related SR (e.g., SR requesting a beam change, SR requesting an initiation of a BRRS, etc.) in addition to a SR requesting resource allocation for data in a NR system.

In step S1105, the UE receives, from a base station, SRS configuration information related to SRS transmission. Here, the SRS configuration information includes at least one of CS index information of a sequence (e.g., Zadoff-Chu sequence, pseudo-random sequence) related to the SRS transmission, comb information representing a comb structure in which the sequence is transmitted, or hopping bandwidth (i.e., subband on which the SRS is transmitted) information related to the SRS transmission. For example, the UE may receive, from the base station, configuration information about CS indexes, a transmission location of a comb structure, and a hopping pattern, etc. described in the second embodiment.

Next, in step S1110, the UE transmits, to the base station, at least one SRS indicating a specific SR of a plurality of SRs based on the SRS configuration information. Here, the specific SR is indicated according to at least one of an CS index selected based on the CS index information, a comb index (e.g., an even comb index, an odd comb index) selected based on the comb information, or a hopping pattern based on the hopping bandwidth information. In other words, the specific SR may be indicated (transmitted) according to at least one combination of the selected CS index, the comb index, or the hopping pattern.

In this instance, the plurality of SRs, as described above, may include at least one of a SR (i.e., data SR) related to resource allocation for data or a SR (i.e., beam related SR) for requesting a scheduling related to a beam. In particular, the SR for requesting the scheduling related to the beam may include at least one of a SR for requesting a beam change or a SR for requesting an initiation of a reference signal related to beam refinement.

As described above, the CS index information related to the SRS transmission (i.e., applied to a sequence used in the SRS transmission) may include at least one of a first CS index group or a second CS index group. Here, the first CS index group may represent the SR related to the resource allocation for the data, and the second CS index group may represent the SR for requesting the scheduling related to the beam. In particular, the second CS index group may include at least one of a first CS index subgroup or a second CS index subgroup. The first CS index subgroup may represent a SR for requesting a beam change, and the second CS index subgroup may represent a SR for requesting an initiation of a reference signal related to beam refinement.

As described above, the comb information may include a first comb index (e.g., even comb index) and a second comb index (e.g., odd comb index). In this case, the first comb index may represent the SR related to the resource allocation for the data, and the second comb index may represent the SR for requesting the scheduling related to the beam. That is, the first comb index may be allocated to the data SR, and the second comb index may be allocated to the beam related SR.

As shown in FIG. 9, the first comb index may represent an even comb structure consisting of indexes of even-numbered subcarriers, and the second comb index may represent an odd comb structure consisting of indexes of odd-numbered subcarriers. When the SR related to the resource allocation for the data includes at least one of a first SR or a second SR, a first CS index and a second CS index among CS indexes corresponding to the first comb index may represent the first SR and the second SR, respectively. When the SR for requesting the scheduling related to the beam includes at least one of a third SR or a fourth SR, a third CS index and a fourth CS index among CS indexes corresponding to the second comb index may represent the third SR and the fourth SR, respectively. That is, the UE may be configured to combine the comb index and the CS index and transmit the specific SR.

As shown in FIG. 11, the UE may transmit the at least one SRS via not one system bandwidth but one or more subbands (i.e., one or more hoping bandwidths). In this case, the hopping bandwidth information included in the SRS configuration information may include information about one or more subbands included in a bandwidth allocated for the SRS transmission. The hopping pattern may represent an order of the one or more subbands on which the at least one SRS is transmitted. That is, as described above, the hopping pattern may be determined according to the order in which the subbands are transmitted.

The hopping pattern may include at least one of a first hopping pattern group and a second hopping pattern group that are determined according to the order. The first hopping pattern group may represent the SR related to the resource allocation for the data, and the second hopping pattern group may represent the SR for requesting the scheduling related to the beam.

The UE may receive the SRS configuration information from the base station via at least one of higher layer signaling or downlink control information.

Overview of Device to which the Present Invention is Applicable

FIG. 12 illustrates a block configuration diagram of a wireless communication device to which methods proposed by the present specification are applicable.

Referring to FIG. 12, a wireless communication system includes a base station 1210 and a plurality of UEs 1220 positioned in an area of the base station 1210.

The base station 1210 includes a processor 1211, a memory 1212, and a radio frequency (RF) unit 1213. The processor 1211 implements functions, processes, and/or methods proposed in FIGS. 1 to 8. Layers of a radio interface protocol may be implemented by the processor 1211. The memory 1212 is connected to the processor 1211 and stores various types of information for driving the processor 1211. The RF unit 1213 is connected to the processor 1211 and transmits and/or receives a radio signal.

The UE 1220 includes a processor 1221, a memory 1222, and a RF unit 1223.

The processor 1221 implements functions, processes, and/or methods proposed in FIGS. 1 to 11. Layers of a radio interface protocol may be implemented by the processor 1221. The memory 1222 is connected to the processor 1221 and stores various types of information for driving the processor 1221. The RF unit 1223 is connected to the processor 1221 and transmits and/or receives a radio signal.

The memories 1212 and 1222 may be inside or outside the processors 1211 and 1221 and may be connected to the processors 1211 and 1221 through various well-known means. The base station 1210 and/or the UE 1220 may have a single antenna or multiple antennas.

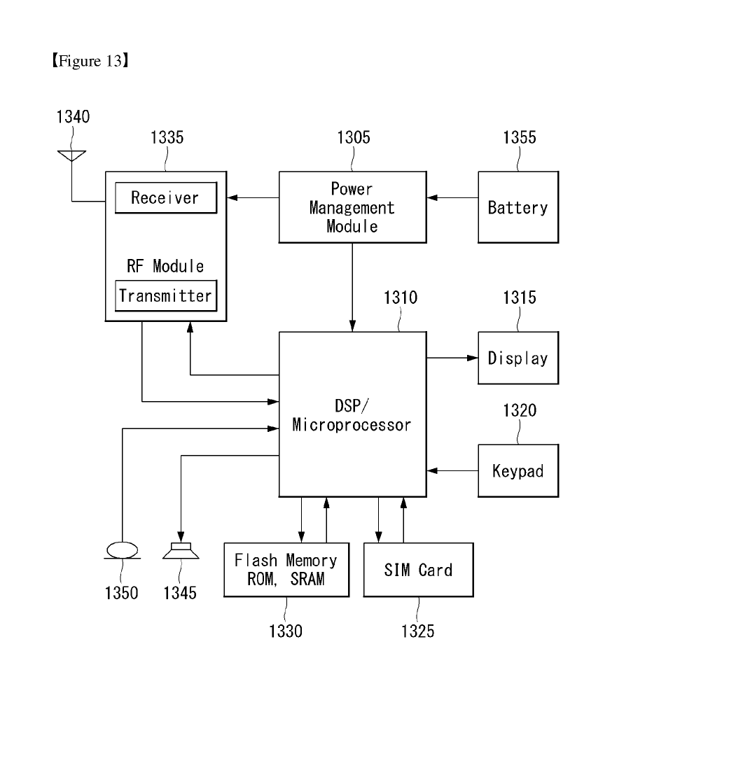

FIG. 13 illustrates a block configuration diagram of a communication device according to an embodiment of the present invention.

In particular, FIG. 13 illustrates the UE illustrated above in FIG. 12 in more detail.

Referring to FIG. 13, the UE may include a processor (or digital signal processor (DSP)) 1310, an RF module (or RF unit) 1335, a power management module 1305, an antenna 1340, a battery 1355, a display 1315, a keypad 1320, a memory 1330, a subscriber identification module (SIM) card 1325 (which is optional), a speaker 1345, and a microphone 1350. The UE may also include a single antenna or multiple antennas.

The processor 1310 implements functions, processes, and/or methods proposed in FIGS. 1 to 11. Layers of a radio interface protocol may be implemented by the processor 1310.

The memory 1330 is connected to the processor 1310 and stores information related to operations of the processor 1310. The memory 1330 may be inside or outside the processor 1310 and may be connected to the processors 1310 through various well-known means.

A user inputs instructional information, such as a telephone number, for example, by pushing (or touching) buttons of the keypad 1320 or by voice activation using the microphone 1350. The processor 1310 receives the instructional information and is processed to perform an appropriate function, such as to dial the telephone number. Operational data may be extracted from the SIM card 1325 or the memory 1330. Further, the processor 1310 may display instructional information and operational information on the display 1315 for the user's reference and convenience.

The RF module 1335 is connected to the processor 1310 and transmits and/or receives an RF signal. The processor 1310 delivers instructional information to the RF module 1335 in order to initiate communication, for example, transmit radio signals configuring voice communication data. The RF module 1335 includes a receiver and a transmitter to receive and transmit radio signals. An antenna 1340 functions to transmit and receive radio signals. Upon reception of the radio signals, the RF module 1335 may deliver signals to be processed by the processor 1310 and convert the signal into a baseband. The processed signal may be converted into audible or readable information output via the speaker 1345.

In the aforementioned embodiments, the elements and characteristics of the present invention have been combined in specific forms. Each of the elements or characteristics may be considered to be optional unless otherwise described explicitly. Each of the elements or characteristics may be implemented in a form to be not combined with other elements or characteristics. Furthermore, some of the elements and/or the characteristics may be combined to form an embodiment of the present invention. Order of the operations described in the embodiments of the present invention may be changed. Some of the elements or characteristics of an embodiment may be included in other embodiments or may be replaced with corresponding elements or characteristics of other embodiments. It is evident that an embodiment may be constructed by combining claims not having an explicit citation relation in the claims or may be included as a new claim by amendments after filing an application.

The embodiment according to the present invention may be implemented by various means, for example, hardware, firmware, software or a combination of them. In the case of an implementation by hardware, the embodiment of the present invention may be implemented using one or more application-specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In the case of an implementation by firmware or software, the embodiment of the present invention may be implemented in the form of a module, procedure or function for performing the aforementioned functions or operations. Software code may be stored in the memory and driven by the processor. The memory may be located inside or outside the processor and may exchange data with the processor through a variety of known means.

It is evident to those skilled in the art that the present invention may be materialized in other specific forms without departing from the essential characteristics of the present invention. Accordingly, the detailed description should not be construed as being limitative from all aspects, but should be construed as being illustrative. The scope of the present invention should be determined by reasonable analysis of the attached claims, and all changes within the equivalent range of the present invention are included in the scope of the present invention.

### INDUSTRIAL APPLICABILITY

The present invention has described a method for transmitting a scheduling request in a wireless communication system focusing on examples applied to 3GPP LTE/LTE-A system and 5G system (new RAT system), but can be applied to various wireless communication systems.

1. A method for transmitting, by a user equipment (UE), a scheduling request (SR) in a wireless communication system, the method comprising:
receiving, from a base station, sounding reference signal (SRS) configuration information related to SRS transmission; and
transmitting, to the base station, at least one SRS related to a specific SR of a plurality of SRs based on the SRS configuration information,
wherein the SRS configuration information includes at least one of cyclic shift (CS) index information of a sequence related to the SRS transmission, comb information representing a comb structure in which the sequence is transmitted, or hopping bandwidth information related to the SRS transmission, and
wherein the specific SR is indicated according to at least one of an CS index selected based on the CS index information, a comb index selected based on the comb information, or a hopping pattern based on the hopping bandwidth information.

2. The method of claim 1, wherein the plurality of SRs includes at least one of a SR related to resource allocation for data or a SR for requesting a scheduling related to a beam.

3. The method of claim 2, wherein the SR for requesting the scheduling related to the beam includes at least one of a SR for requesting a beam change or a SR for requesting an initiation of a reference signal related to beam refinement.

4. The method of claim 2, wherein the CS index information includes at least one of a first CS index group or a second CS index group,
wherein the first CS index group represents the SR related to the resource allocation for the data, and
wherein the second CS index group represents the SR for requesting the scheduling related to the beam.

5. The method of claim 4, wherein the second CS index group includes at least one of a first CS index subgroup or a second CS index subgroup,
wherein the first CS index subgroup represents a SR for requesting a beam change, and
wherein the second CS index subgroup represents a SR for requesting an initiation of a reference signal related to beam refinement.

6. The method of claim 2, wherein the comb information includes a first comb index and a second comb index,
wherein the first comb index represents the SR related to the resource allocation for the data, and
wherein the second comb index represents the SR for requesting the scheduling related to the beam.

7. The method of claim 6, wherein the first comb index represents an even comb structure consisting of indexes of even-numbered subcarriers, and
wherein the second comb index represents an odd comb structure consisting of indexes of odd-numbered subcarriers.

8. The method of claim 6, wherein when the SR related to the resource allocation for the data includes at least one of a first SR or a second SR, a first CS index and a second CS index among CS indexes corresponding to the first comb index represent the first SR and the second SR, respectively, and
wherein when the SR for requesting the scheduling related to the beam includes at least one of a third SR or a fourth SR, a third CS index and a fourth CS index among CS indexes corresponding to the second comb index represent the third SR and the fourth SR, respectively.

9. The method of claim 2, wherein the hopping bandwidth information includes information about one or more subbands included in a bandwidth allocated for the SRS transmission, and
wherein the hopping pattern represents an order of the one or more subbands on which the at least one SRS is transmitted.

10. The method of claim 9, wherein the hopping pattern includes at least one of a first hopping pattern group or a second hopping pattern group that are determined according to the order,
wherein the first hopping pattern group represents the SR related to the resource allocation for the data, and
wherein the second hopping pattern group represents the SR for requesting the scheduling related to the beam.

11. The method of claim 2, wherein the sequence includes at least one of a Zadoff-Chu sequence or a pseudo-random sequence.

12. The method of claim 2, wherein the SRS configuration information is received via at least one of higher layer signaling or downlink control information.

13. A user equipment (UE) for transmitting a scheduling request (SR) in a wireless communication system, the UE comprising:
a transceiver configured to transmit and receive a radio signal; and
a processor functionally coupled to the transceiver,
wherein the processor is controlled to:
receive, from a base station, sounding reference signal (SRS) configuration information related to SRS transmission; and
transmit, to the base station, at least one SRS related to a specific SR of a plurality of SRs based on the SRS configuration information,
wherein the SRS configuration information includes at least one of cyclic shift (CS) index information of a sequence related to the SRS transmission, comb information representing a comb structure in which the sequence is transmitted, or hopping bandwidth information related to the SRS transmission, and
wherein the specific SR is indicated according to at least one of an CS index selected based on the CS index information, a comb index selected based on the comb information, or a hopping pattern based on the hopping bandwidth information.

14. The UE of claim 13, wherein the plurality of SRs includes at least one of a SR related to resource allocation for data or a SR for requesting a scheduling related to a beam.
